(19) United States
(12) Patent Application Publication
(10) Pub. No.: US 2020/0216358 A1
(43) Pub. Date: Jul. 9, 2020

(54) SURFACE-MODIFIED GLASS FIBERS FOR REINFORCING CONCRETE, AND METHOD FOR PRODUCING SAME

(71) Applicant: LEIBNIZ-INSTITUT FUER POLYMERFORSCHUNG DRESDEN E.V., Dresden (DE)

(72) Inventor: Dieter LEHMANN, Dresden (DE)

(73) Assignee: LEIBNIZ-INSTITUT FUER POLYMERFORSCHUNG DRESDEN E.V., Dresden (DE)

(21) Appl. No.: 16/622,487

(22) PCT Filed: Jun. 14, 2018
(86) PCT No.: PCT/EP2018/065804

§ 371 Date: Mar. 23, 2020

(30) Foreign Application Priority Data
Jun. 15, 2017 (DE) 10 2017 113 205.8

(51) Int. Cl. C04B 20/00; C04B 20/10; E04C 5/07; C03C 25/1025; C03C 25/16; C03C 25/30; C03C 25/326; C03C 25/36; C03C 25/323; C03C 25/50

(52) U.S. Cl. CPC C04B 20/0068; C04B 20/1037; C04B 20/1033; E04C 5/073; C03C 25/103; C03C 25/50; C03C 25/30; C03C 25/326; C03C 25/36; C03C 25/323; C03C 25/16

(57) ABSTRACT

The invention pertains to the fields of chemistry and construction and relates to surface-modified glass fiber for reinforcing concrete, such as those which can be used in textile-reinforced concrete (textile concrete), for example. The object of the present invention is to provide surface-modified glass fibers for reinforcing concrete, which glass fibers are at least substantially protected against an alkaline attack caused by the calcium hydroxides released during the cement reaction and/or dissolution and leaching processes generated thereby. The object is attained with surface-modified glass fibers for reinforcing concrete which are at least partially covered at least with a hydrolysis-stable and alkali-resistant cationic polyelectrolyte and/or hydrolysis-stable and alkali-resistant cationic polyelectrolyte mixture and/or with a hydrolysis-stable and alkali-resistant polyelectrolyte complex and coupled to the glass fiber surface via a (polyelectrolyte) complex formation process by means of ionic bonding, with the hydrolysis-stable and alkali-resistant polyelectrolyte complex A thereby being formed, wherein at least one additional (co)polymer at least partially covers the polyelectrolyte complex A and is coupled with the polyelectrolyte A via ionic and/or covalent bonds.

The invention pertains to the fields of chemistry and construction and relates to surface-modified glass fibers for reinforcing concrete, such as those which can be used in textile-reinforced concrete (textile concrete), for example.

Owing to the mechanical properties and the price/performance ratio, glass fibers are used on a wide scale as reinforcing materials in thermosetting materials/plastics, thermoplastic materials/thermoplastics, and elastomer materials/plastics—but also as concrete-reinforcing material in construction.

Glass fibers used as commercial reinforcing materials are typically produced from the melt and further processed into numerous products.

For the various applications, glass fibers are usually processed into roving, nonwoven fiber, mats or fabric. By contrast, oriented fibers are used for profile production.

In additional to steel as reinforcing material, due to the low resistance against tensile forces textile structures, made of AR-glass fibers or carbon fibers for example, are increasingly being inlaid into concrete as textile fiber reinforcements in order to absorb tensile and/or compressive forces. Concrete with technical textiles made of fibers of this type as reinforcements is generally referred to as textile concrete.

Structures and prefabricated parts made of textile concrete are described in EP 2 530 217 A1 and DE 10 2015 100 438 A1, for example.

The advantage of textile fiber reinforcements is, among other things, that they can be arranged in the surface-proximate edge zone of the component, since unlike reinforcements made of structural steel they do not rust and therefore also require only minor concrete covering or none at all.

For the different applications in textile concrete, glass fiber types specifically manufactured in each case are produced and usually processed into roving.

Reinforcement fibers generally influence the properties of a composite material. Glass fibers are commercially available as reinforcing fibers in different grades as [Wikipedia.org/wiki.Glasfaser, as of: Jan. 2, 2017]:
E-glass (E=electric): standard glass fiber with a 90% market share, not resistant in basic and acidic environments
S-glass, R-glass: glass fiber with increased strength
M-glass: glass fiber with increased stiffness (elastic modulus)
C-glass: glass fiber with increased chemical resistance
ECR-glass: glass fiber with particularly high corrosion resistance
D-glass: glass fiber with low dielectric loss factor
AR-glass (AR=alkaline resistant): glass fiber specially developed for application in concrete, enriched with zirconium(IV) oxide, largely resistant to a basic environment)
Q-glass (Q=quartz): quartz glass fiber (SiO₂) for application at high temperatures of up to 1450° C.
Hollow glass fibers: glass fibers (usually E-glass) with a hollow cross-section
   Note: R-glass, S-glass and M-glass are alkali-free and have increased moisture resistance.

The AR-glass fibers were specially developed and used for application in textile-reinforced concrete, which glass fibers exhibit a better alkali stability compared to E-glass fibers, but which, as current publications attest to, are also damaged by alkaline attack [dissertations by Orlowski “Zur Dauerhaftigkeit von AR-Glasbewehrung in Textilbeton” [“On the Stability of AR-Glass Fibers in Textile Concrete”], Diss. RWTH Aachen, 2004 and Scheffler “Zur Beurteilung von AR-Glasfasern in alkalischer Umgebung” [“On the Assessment of AR-Glass Fibers in Alkaline Environments”], Diss. TU Dresden, 2009].

The production of glass fibers takes place according to the prior art, with sizing materials thereby being used. Where notch-sensitive, sized glass fibers of this type are used, a suitable further processing, mainly in a textile operation, is achieved without the glass fibers breaking. The development of sizing materials primarily took place in the 1960s through the 1980s. The sizing materials are, virtually without exception, composed of mixtures in which starch and/or polymers, such as polyurethane derivatives and/or epoxy resins and/or silanes and/or waxes, etc. for example, are used and processed as a dispersion. In polymer-based sizing material formulations, additional auxiliary materials such as antistatic agents, lubricants and bonding agents, such as silanes, are often also used. For the sake of technological simplification, the sizing material formulations are produced as a multi- or poly-component mixture in the form of an aqueous dispersion in the one-pot processing system and are processed in this manner. In the production process, the glass fibers are wetted with sizing material via an immersion roller, and the individual filaments are usually bundled into rovings. Through the application of sizing material, a certain cohesion of the glass fiber filaments in the roving is also achieved. The respective sizing material composition is tailored such that an optimal composite bond of the structural elements into which the roving is worked is achieved. Current sizing material formulations are usually “black box systems,” which means that there is only little or no publicly accessible information about the components and the formulation thereof.

Sized glass fibers usually exhibit an excellent lubricity or sliding capacity with a minimum of wear or broken ends.

According to DE 23 15 242 A1, polyazamides modified with organosilicon, the production and use of which polyazamides is known, comprise a secondary and/or tertiary amino group and a carboxamide group in the backbone thereof and are bonded via a polyvalent organic group to a silicon atom. The polyazimides, which are polar and hygroscopic, are produced via a Michael addition reaction or haloalkylation.

The examination of the adhesive strength of these silicon-containing polyazamides was carried out in DE 23 15 242 A1, Example 54. The glass plates that were surface-treated with these polyazamides that are modified with organosilicon showed excellent adhesion between the glass surface and the cured epoxy resin.

According to DE 23 15 242 A1, Example 54, the glass plates were treated in water after the application and curing of epoxy resin, and it was determined that the epoxy resin showed no adhesion to the glass plates surface-treated with polyethyleneimine and unmodified polyazamide.

Accordingly, the use of unmodified polyelectrolytes such as polyethyleneimine and polyazamide would not be suitable for a glass fiber modification, which means that glass surfaces, and by extension glass fibers, which are treated with silane-free cationic polyelectrolytes such as polyethyleneimine and polyazamide and subsequently reacted with epoxy resin do not form a (hydrolysis-)stable bond in water.

With this Example 54, it is thus stated that the glass surfaces, and by extension glass fibers, which were treated with polyethyleneimine having a molecular weight of 1200 and with unmodified polyazamide and subsequently reacted with epoxy resin do not form a (hydrolysis-)stable bond in water and are therefore not suitable as surface modifying agents for glass fibers.

As is known, sizing materials on glass fibers are intended to prevent filament damage, such as glass fiber breakage and abrasion for example, through the formation of protective layers during the processing of the sized glass fibers. Furthermore, the sizing material produces the contact of the individual glass filaments with one another and ensures the combination of the filaments into a workable thread. For this reason, the sizing material must be distributed on the glass fiber surface and should maintain a “sticking” effect after the drying.

During the production of the glass fibers in the spinning process, the sizing material is applied to the individual glass filaments by means of a sizing roller, wherein the solid materials of the sizing material must not exhibit any tendency to agglomerate.

Even though a certain protection against corrosive attack in the alkaline environment of concrete is already achieved by the increased ZrO₂ content in the AR-glass fiber, the glass fiber sizing material is intended to function as an additional diffusion barrier, for which reason the sizing material should also be stable at higher pH levels.

Thomason and Dwight [Thomason, J. L.; Dwight, D. W.; Composites Part A: Applied Science and Manufacturing 30 (1999), 1401-1413] and Gao et al. [Gao, S. L.; Mader, E.; Abdkader, A.; Offermann, P.; Journal of Non-Crystalline Solids 325 (2003), 230-241] have described that there is a merely irregular distribution of the sizing material on the glass fiber surface. Accordingly, there is no consistent protection of the glass fiber surface by the sizing material.

The SEM images according to FIGS. 1 and 2 show, by way of example, that sizing materials do not form a closed film on the glass fiber, but rather that the sizing material from the dispersion is only present such that it is adsorbed locally, that is, distributed at points, on the glass fiber surface during the glass fiber production. Accordingly, most of the glass fiber surface is present in an unmodified state as free/“naked” glass fiber, which constitutes the problem with regard to the alkali resistance in the use of E-glass fibers as a standard fiber with the largest market share and also in the use of AR-glass fibers in textile concrete.

This is the actual problem for the use of glass fibers for textile-reinforced concrete. The surface coverage via the sizing material treatment is merely incomplete, whereby the alkaline attack and the damage to the glass fibers in the textile concrete also actually occurs, which the dissertations by Orlowski and Scheffler also verify for the AR-glass fibers.

Thus, a subsequent coating of sized glass fibers with polymers, such as with epoxy resin for example, only results in isolated intensive interactions at the local sizing material points, and not in a full-area material bond via an ionic interaction with the sizing material between the glass fiber surface and the coating agent. The other, previously “naked” regions of the glass fiber are only in loose contact with the coating material, so that these points are penetrated in a basic medium such as concrete, which over a longer period of time then results in damage to the glass fiber as a reinforcing material overall. Even the alkali-resistant AR-glass fibers specially developed for textile concrete are attacked in an alkaline medium, as verified by the dissertations by Orlowski and Scheffler.

According to Orlowsky [Diss. RWTH Aachen, 2004], even AR-glass fibers which are specifically developed and used for reinforcing plaster, screed, concrete or mortar lose strength in cement-based binding agents with a high pH when stored in water for long periods due to the following damage mechanisms . . . in the cement-based binding agent”:
“corrosion of the AR-glass caused by dissolution and leaching processes . . . .
mechanical damage as a result of ingrowing hydration products that can both cause a loss of ductility in the composite material and also exert transverse compression on the filaments under load . . . .
static fatigue: The growth of imperfections in the AR-glass surface causes a premature failure of the glass . . . , wherein the causes for the growth of imperfections have not been fully clarified.”

The object of the present invention is to provide surface-modified glass fibers for reinforcing concrete, which glass fibers are substantially protected against an alkaline attack caused by the calcium hydroxides released during the cement reaction and/or dissolution and leaching processes generated thereby, and to provide a simple and cost-effective method for producing surface-modified glass fibers of this type.

The object is attained with the invention disclosed in the patent claims, wherein combinations of the individual dependent patent claims are also included within the meaning of a logical AND operation, provided that they are not mutually exclusive.

The surface-modified glass fibers for reinforcing concrete according to the invention are at least partially covered at least with a hydrolysis-stable and alkali-resistant cationic polyelectrolyte and/or hydrolysis-stable and alkali-resistant cationic polyelectrolyte mixture and/or with a hydrolysis-stable and alkali-resistant polyelectrolyte complex and coupled to the glass fiber surface via a (polyelectrolyte) complex formation process by means of ionic bonding, with the hydrolysis-stable and alkali-resistant polyelectrolyte complex A thereby being formed, wherein at least one additional (co)polymer at least partially covers the polyelectrolyte complex A and is coupled with the polyelectrolyte A via ionic and/or covalent bonds.

Advantageously, a hydrolysis-stable and alkali-resistant polyelectrolyte complex A is present which has been created
by a (polyelectrolyte) complex formation of the glass fiber surface with hydrolysis-stable and alkali-resistant cationic polyelectrolytes; and/or
by a (polyelectrolyte) complex formation of the glass fiber surface with hydrolysis-stable and alkali-resistant cationic polyelectrolyte mixtures; and/or
by a (polyelectrolyte) complex formation of the glass fiber surface with hydrolysis-stable and alkali-resistant polyelectrolyte complexes with an excess of cationic charges, which polyelectrolyte complexes have been produced before being applied to the glass fiber surface.

Likewise advantageously, the hydrolysis-stable and alkali-resistant polyelectrolyte complex A that was formed on the glass fiber surface covers the glass fiber surface completely or essentially completely, and/or the additional (co)polymer covers the polyelectrolyte complex A completely or essentially completely.

Also advantageously, the following are present as hydrolysis-stable and alkali-resistant cationic polyelectrolyte or hydrolysis-stable and alkali-resistant cationic polyelectrolyte mixture:
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

And also advantageously, the following are present as functionalities on the hydrolysis-stable and alkali-resistant cationic polyelectrolyte or hydrolysis-stable and alkali-resistant cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have substituents on the nitrogen atom with an additional reactive and/or activatable functional group and/or olefinically unsaturated double bond, and/or
have amino groups and/or quaternary ammonium groups which are at least partially chemically modified on the nitrogen atom via alkylation reactions, with at least one additional reactive and/or activatable functional group and/or at least one olefinically unsaturated double bond, and/or
have amino groups and/or quaternary ammonium groups and amide groups which are chemically modified via acylation reactions of amino groups to amide, with at least one additional reactive and/or activatable functional group and/or at least one olefinically unsaturated double bond.

It is also advantageous if at least one anionic polyelectrolyte or one anionic polyelectrolyte mixture without and/or with at least one additional reactive and/or activatable functional group different from the anionic group and/or with at least one olefinically unsaturated double bond are present as functionalities on the hydrolysis-stable and alkali-resistant cationic polyelectrolyte or hydrolysis-stable and alkali-resistant cationic polyelectrolyte mixture attached to the glass fiber surface.

It is furthermore advantageous if the following are present as anionic polyelectrolyte or anionic polyelectrolyte mixture:

(a) (meth)acrylic acid copolymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylic acid group, and which are preferably water-soluble, and/or
(b) modified maleic acid (anhydride) copolymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of maleic acid (anhydride) groups, and which are preferably water-soluble, and/or
(c) modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of itaconic acid (anhydride) groups, and which are preferably water-soluble, and/or
(d) modified fumaric acid copolymers which are preferably present in the acid and/or monoester and/or monoamide form, and/or which are present without and/or with at least one additional reactive and/or activatable functional group that was introduced via the copolymerization, and or which are present with at least one additional reactive and/or activatable functional group and/or at least one olefinically unsaturated double bond that are coupled via a polymer-analogous reaction/modification of fumaric acid groups, and which are preferably water-soluble, and/or
(e) anionically modified (meth)acrylamide (co)polymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylamide group, and which are preferably water-soluble, and/or
(f) sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or
(g) (co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous (co)polymer reaction/modification, and which are preferably water-soluble.

It is likewise advantageous if the hydrolysis-stable and alkali-resistant cationic polyelectrolytes or the hydrolysis-stable and alkali-resistant cationic polyelectrolyte mixture have a molecular weight under 50,000 dalton, preferably in the range between 400 dalton and 10,000 dalton.

And it is also advantageous if at least one at least difunctional and/or difunctionalized oligomeric and/or macromolecular (co)polymer with functional groups and/or olefinically unsaturated double bonds is present as additional (co)polymer.

It is also advantageous if thermoplastics and/or thermosets and/or elastomers are present as additional (co)polymer.

It is likewise advantageous if polyester resins (UP resins), vinyl ester resins and epoxy resins are present as thermosetting (co)polymers, and if polyurethane, polyamide and polyolefins, such as polyethylene or polypropylene, and PVC are present as thermoplastic co(polymers), wherein the polyolefins are present such that they are grafted with (meth)acrylic acid derivatives and/or maleic anhydride.

In the reinforcing materials according to the invention for textile concrete with surface-modified glass fibers, a hydrolysis-stable and alkali-resistant polyelectrolyte complex A is present in an at least partially covering manner on glass fiber surfaces without sizing material and silane, which polyelectrolyte complex comprises functional groups and/or olefinically unsaturated double bonds and is present such that it is coupled via chemically covalent bonds with additional (co)polymers after a reaction with functional groups and/or olefinically unsaturated double bonds.

Advantageously, at least one at least difunctional and/or difunctionalized oligomeric and/or macromolecular (co)polymer with functional groups and/or olefinically unsaturated double bonds are present as additional (co)polymers.

Likewise advantageously, thermoplastics and/or thermosets and/or elastomers are present as (co)polymer.

Also advantageously, amino groups, preferably primary and/or secondary amino groups, and/or quaternary ammonium groups are present as functionalities of the adsorbed hydrolysis-stable cationic polyelectrolytes coupled via ionic bonds.

In the method according to the invention for producing surface-modified glass fibers, a hydrolysis-stable and alkali-resistant cationic polyelectrolyte and/or a hydrolysis-stable alkali-resistant cationic polyelectrolyte mixture and/or a hydrolysis-stable and alkali-resistant polyelectrolyte complex with an excess of cationic charges is applied from an aqueous solution at a concentration of maximally 5 wt % to the glass fiber surfaces in an at least partially covering manner during or after the production of glass fibers, wherein hydrolysis-stable and alkali-resistant cationic polyelectrolytes and/or hydrolysis-stable and alkali-resistant cationic polyelectrolyte mixtures with a molecular weight under 50,000 dalton and/or a hydrolysis-stable and alkali-resistant polyelectrolyte complex with an excess of cationic charges are used, and at least one additional (co)polymer is subsequently applied in an at least partially covering manner to the hydrolysis-stable and alkali-resistant polyelectrolyte complex A created on the glass surface.

Polyelectrolytes which are not subsequently alkylated and/or acylated and/or sulfamidated after production are advantageously used as hydrolysis-stable and alkali-resistant cationic polyelectrolytes, or polyelectrolyte mixtures that are not subsequently alkylated and/or acylated and/or sulfamidated after production are advantageously used as hydrolysis-stable and alkali-resistant cationic polyelectrolyte mixtures.

The following are also advantageously used as hydrolysis-stable and alkali-resistant unmodified cationic polyelectrolyte, as a pure substance or substances or in a mixture, preferably dissolved in water:
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

Also advantageously, hydrolysis-stable and alkali-resistant cationic polyelectrolytes and/or hydrolysis-stable and alkali-resistant cationic polyelectrolyte mixtures and/or hydrolysis-stable and alkali-resistant polyelectrolyte complexes with an excess of cationic charges are used at a concentration of maximally 5 wt % in water or in water with the addition of acid, such as carboxylic acid, for example formic acid and/or acetic acid, and/or mineral acid, without additional sizing material or sizing material components and/or silanes.

And also advantageously, hydrolysis-stable and alkali-resistant cationic polyelectrolytes which are not subsequently alkylated and/or acylated and/or sulfamidated after production and/or hydrolysis-stable and alkali-resistant cationic polyelectrolyte mixtures that are not subsequently alkylated and/or acylated and/or sulfamidated after production are used at a concentration of <2 wt %, and particularly preferably at ≤0.8 wt %.

It is also advantageous if hydrolysis-stable and alkali-resistant cationic polyelectrolytes and/or hydrolysis-stable and alkali-resistant cationic polyelectrolyte mixtures with a molecular weight under 50,000 dalton, preferably in the range between 400 dalton and 10,000 dalton, are used.

It is furthermore advantageous if a modified hydrolysis-stable and alkali-resistant cationic polyelectrolyte and/or a hydrolysis-stable and alkali-resistant cationic polyelectrolyte mixture that is partially alkylated and/or acylated and/or reacted with carboxylic acid derivatives and/or sulfamidated in a subsequent reaction following production, and is thus equipped with a substituent having reactive and/or activatable groups for a coupling reaction, is then, having the reactive and/or activatable groups of the covalently coupled substituent, reacted with additional materials to form a composite material via at least one functional group and/or via at least one olefinically unsaturated double bond without crosslinking of the hydrolysis-stable and alkali-resistant cationic polyelectrolyte or of the hydrolysis-stable and alkali-resistant cationic polyelectrolyte mixture.

It is likewise advantageous if the partial alkylation of the hydrolysis-stable and alkali-resistant cationic polyelectrolyte or of the hydrolysis-stable and alkali-resistant cationic polyelectrolyte mixture is achieved, with substituents having reactive groups thereby being introduced, through haloalkyl derivatives and/or (epi)halohydrin compounds and/or epoxy compounds and/or compounds which enter into a Michael-analogous addition, advantageously such as acrylates and/or acrylonitrile with amines.

And it is also advantageous if the partial acylation of the hydrolysis-stable and alkali-resistant cationic polyelectrolyte or of the hydrolysis-stable and alkali-resistant cationic polyelectrolyte mixture is achieved, with substituents having reactive groups thereby being introduced, through carboxylic acids and/or carboxylic acid halides and/or carboxylic acid anhydrides and/or carboxylic acid esters and/or diketenes, or if a quasi-acylation is achieved through isocyanates and/or urethanes and/or carbodiimides and/or uretdiones and/or allophanates and/or biurets and/or carbonates.

It is also advantageous if the hydrolysis-stable and alkali-resistant cationic polyelectrolytes and/or the hydrolysis-stable and alkali-resistant cationic polyelectrolyte mixture and/or the hydrolysis-stable and alkali-resistant polyelectrolyte complexes with an excess of cationic charges are used such that they are dissolved in water, preferably as an ammonium compound, wherein in the case of primary and/or secondary and/or tertiary amino groups carboxylic acid(s) and/or mineral acid(s) are added to the aqueous solution to convert the amino groups into the ammonium form.

It is furthermore advantageous if modified glass fiber surfaces that are at least partially, and preferably completely, covered at least with a hydrolysis-stable and alkali-resistant cationic polyelectrolyte or a hydrolysis-stable and alkali-resistant cationic polyelectrolyte mixture and/or a hydrolysis-stable and alkali-resistant polyelectrolyte complex with an excess of cationic or anionic charges are, directly following the production and coating/surface modification thereof and/or at a later point, reacted with additional materials, with chemically covalent bonds thereby being formed.

It is likewise advantageous if the modified glass fiber surfaces are wound and/or intermediately stored as roving and are subsequently reacted with additional materials, with chemically covalent bonds thereby being formed.

And it is also advantageous if the hydrolysis-stable and alkali-resistant cationic polyelectrolyte or the hydrolysis-stable and alkali-resistant cationic polyelectrolyte mixture and/or the hydrolysis-stable and alkali-resistant polyelectrolyte complex with an excess of cationic or anionic charges comprises reactive groups in the form of functional groups and/or olefinically unsaturated double bonds, which groups are reacted with functionalities of the additional materials, with chemically covalent bonds thereby being formed.

And lastly, it is advantageous if an aqueous solution with a concentration of maximally 5 wt % of a hydrolysis-stable and alkali-resistant cationic polyelectrolyte and/or of a hydrolysis-stable and alkali-resistant cationic polyelectrolyte mixture and/or of a hydrolysis-stable and alkali-resistant polyelectrolyte complex with an excess of cationic charges is applied in an at least partially covering manner to commercially produced and sized glass fiber surfaces, or to glass fiber surfaces without sizing material and silane, wherein cationic polyelectrolytes or cationic polyelectrolyte mixtures with a molecular weight under 50,000 dalton are used.

With the solution according to the invention, it is possible for the first time to provide surface-modified glass fibers for reinforcing concrete which are at least substantially protected against an alkaline attack caused by the calcium hydroxides released during the cement reaction and/or dissolution and leaching processes generated thereby, and to provide a simple and cost-effective method for producing surface-modified glass fibers of this type.

With the solution according to the invention, it is in particular possible to provide glass fibers which are surface-modified and do not have sizing material and are thus surface-protected, and which have an as complete as possible degree of coverage with materially bonded modifying agents coupled via ionic bonds in a first modification step and via ionic and/or covalent bonds in subsequent modifications. Not only do surface-modified glass fibers of this type for reinforcing concrete exhibit improved properties overall; they are also very well suited for further processing into textile concrete in particular, since they exhibit a high alkali resistance in textile concrete. With the method according to the invention, glass fibers surface-modified in such a manner can be produced as strand material or tape material.

This is achieved by surface-modified glass fibers for reinforcing concrete which are at least partially covered at least with a hydrolysis-stable and alkali-resistant cationic polyelectrolyte and/or hydrolysis-stable and alkali-resistant cationic polyelectrolyte mixture and/or with a hydrolysis-stable and alkali-resistant polyelectrolyte complex with an excess of cationic charge and coupled to the glass fiber surface via a (polyelectrolyte) complex formation process by means of ionic bonding, with the polyelectrolyte complex A thereby being formed, and with which fibers at least one additional (co)polymer at least partially covers the polyelectrolyte complex A and is coupled with the polyelectrolyte A in an alkali-resistant manner via ionic and/or covalent bonds.

According to the invention, a hydrolysis-stable and alkali-resistant cationic polyelectrolyte is to be understood as meaning all polyelectrolytes that are hydrolysis-stable and/or alkali-resistant and have cationic charges and are colloquially also referred to as a polycation.

According to the invention, a hydrolysis-stable and alkali-resistant cationic polyelectrolyte mixture is to be understood as meaning all mixtures of at least two or more polyelectrolytes that are hydrolysis-stable and/or alkali-resistant and have cationic charges and are colloquially also referred to as a polycation mixture.

Such hydrolysis-stable and/or alkali-resistant cationic polyelectrolytes or hydrolysis-stable and/or alkali-resistant cationic polyelectrolyte mixtures can advantageously be present as
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

The following can advantageously be present as functionalities on the hydrolysis-stable and alkali-resistant cationic polyelectrolyte or hydrolysis-stable and alkali-resistant cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have substituents on the nitrogen atom with an additional reactive and/or activatable functional group and/or olefinically unsaturated double bond, and/or
amino groups and/or quaternary ammonium groups which are at least partially chemically modified on the nitrogen atom via alkylation reactions, with at least one additional reactive and/or activatable functional group and/or at least one olefinically unsaturated double bond, and/or
amino groups and/or quaternary ammonium groups and amide groups which are chemically modified via acylation reactions of amino groups to amide, with at least one additional reactive and/or activatable functional group and/or at least one olefinically unsaturated double bond.

Functionalities of this type on the hydrolysis-stable and alkali-resistant cationic polyelectrolyte or hydrolysis-stable and alkali-resistant cationic polyelectrolyte mixture attached to the glass fiber surface can also be an anionic polyelectrolyte or an anionic polyelectrolyte mixture without and/or with at least one additional reactive and/or activatable functional group different from the anionic group and/or with at least one olefinically unsaturated double bond.

If an anionic polyelectrolyte or an anionic polyelectrolyte mixture is present as a carrier of one or more functionalities, these can be

(a) (meth)acrylic acid copolymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylic acid group, and which are preferably water-soluble, and/or
(b) modified maleic acid (anhydride) copolymers which are preferably present in the acid and/or monoester and/or monoamide and/or preferably in water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of maleic acid (anhydride) groups, and which are preferably water-soluble, and/or
(c) modified itaconic acid (anhydride) (co)polymers which are preferably present in the acid and/or monoester and/or monoamide and/or preferably in water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of itaconic acid (anhydride) groups, and which are preferably water-soluble, and/or
(d) modified fumaric acid copolymers which are preferably present in the acid and/or monoester and/or monoamide form, and/or which are present without and/or with at least one additional reactive and/or activatable functional group that was introduced via the copolymerization, and or which are present with at least one additional reactive and/or activatable functional group and/or at least one olefinically unsaturated double bond that are coupled via a polymer-analogous reaction/modification of fumaric acid groups, and which are preferably water-soluble, and/or
(e) anionically modified (meth)acrylamide (co)polymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylamide group, and which are preferably water-soluble, and/or
(f) sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or
(g) (co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous (co)polymer reaction/modification, and which are preferably water-soluble.

The hydrolysis-stable and alkali-resistant cationic polyelectrolytes present with the surface-modified glass fibers according to the invention or the hydrolysis-stable and alkali-resistant cationic polyelectrolyte mixture advantageously have a molecular weight under 50,000 dalton, preferably in the range between 400 dalton and 10,000 dalton.

Preferably, hydrolysis-stable and alkali-resistant cationic polyelectrolytes and/or hydrolysis-stable and alkali-resistant cationic polyelectrolyte mixtures are present on the glass fiber surface in an at least partially covering manner.

With the anionic glass fiber surface, these then form a hydrolysis-stable and alkali-resistant polyelectrolyte complex A, which has been created via a (polyelectrolyte) complex formation process and is coupled to the glass fiber surface by means of ionic bonding.

However, before application to the glass fiber surface it is also possible that the glass fiber surface is at least partially covered with a hydrolysis-stable and alkali-resistant polyelectrolyte complex with an excess of cationic charge.

According to the invention, such a hydrolysis-stable and alkali-resistant polyelectrolyte complex with an excess of cationic charges includes all polyelectrolyte complex compounds that have been produced from at least one cationic polyelectrolyte and at least one anionic polyelectrolyte and have an excess of cationic charges, and which are colloquially also referred to as “asymmetrical polyelectrolyte complexes.” These hydrolysis-stable and alkali-resistant polyelectrolyte complexes are hydrolysis-stable under the respective processing conditions and, due to the composition and macromolecular structure(s), are water-soluble or dissolved in water, and do not form gelatinous structures.

Also this hydrolysis-stable and alkali-resistant polyelectrolyte complex with an excess of cationic charges, which is formed before application to the glass fiber surface, forms with the anionic glass fiber surface a hydrolysis-stable and alkali-resistant polyelectrolyte complex A, which has been created via a (polyelectrolyte) complex formation process and is coupled to the glass fiber surface by means of ionic bonding.

A hydrolysis-stable and alkali-resistant polyelectrolyte complex A according to the invention is thus to be understood according to the invention as meaning a polyelectrolyte complex which has been created:
by a (polyelectrolyte) complex formation of the glass fiber surface with hydrolysis-stable and alkali-resistant cationic polyelectrolytes; and/or
by a (polyelectrolyte) complex formation of the glass fiber surface with hydrolysis-stable and alkali-resistant cationic polyelectrolyte mixtures; and/or
by a complex formation of the glass fiber surface with hydrolysis-stable and alkali-resistant polyelectrolyte complexes having an excess of cationic charges, which polyelectrolyte complexes have been produced before being applied to the glass fiber surface.

All of these polyelectrolyte complexes according to the invention are created during or after production of the glass fibers via a complex formation process from the anionically charged glass fiber surface and the hydrolysis-stable and alkali-resistant cationic polyelectrolyte and/or polyelectrolyte mixture and/or polyelectrolyte complex having an excess of cationic charges, which polyelectrolyte and/or polyelectrolyte mixture and/or polyelectrolyte complex is applied to the glass fiber surface, and are hereinafter also referred to as polyelectrolyte complex A. Thus, according to the invention, the polyelectrolyte complex A is always formed with the glass fiber surface.

The hydrolysis-stable and alkali-resistant polyelectrolyte complex A is to thereby cover the glass fiber surface essentially completely or as completely as possible.

Furthermore, according to the invention at least one additional (co)polymer is present on the glass fiber, which (co)polymer at least partially covers the polyelectrolyte complex A and is coupled with the polyelectrolyte complex A via ionic and/or covalent bonds.

At least one at least difunctional and/or difunctionalized low-molecular-weight and/or oligomeric and/or (co)polymer with identical or different functional groups and/or olefinically unsaturated double bonds, advantageously such as thermoplastics and/or thermosets and/or elastomers, can be present as additional (co)polymer.

The at least one additional (co)polymer that is formed during or after the attachment and/or is attached as (co)polymer, is to thereby cover the polyelectrolyte complex A essentially completely or as completely as possible.

According to the invention, the at least partial coverage is to be understood as meaning a degree of coverage of at least more than 50% of the glass fiber surface and/or the glass fiber bundle surface by the polyelectrolyte complex A and also by the additional (co)polymers, wherein according to the invention an at least 80% and preferably a 100% coverage is to be achieved, and also is achieved.

Likewise, the hydrolysis-stable and alkali-resistant cationic and/or anionic polyelectrolytes or polyelectrolyte mixtures and/or hydrolysis-stable and alkali-resistant polyelectrolyte complexes with an excess of cationic or anionic charges, which polyelectrolytes or polyelectrolyte mixtures and/or polyelectrolyte complexes are present according to the invention, should be stable, both before the application to the glass fiber surface and also afterwards, in particular under the respectively necessary processing conditions.

Within the scope of the solution according to the invention, the corresponding complexes are to be understood according to the definitions provided below.

Polyelectrolyte complex A has been formed via a complex formation between the glass fiber surface and at least one hydrolysis-stable and alkali-resistant cationic polyelectrolyte and/or hydrolysis-stable and alkali-resistant cationic polyelectrolyte mixture and/or a hydrolysis-stable and alkali-resistant polyelectrolyte complex with an excess of cationic charge, and then covers the glass fiber surface at least partially, essentially completely, or completely.

The hydrolysis-stable and alkali-resistant polyelectrolyte complex with an excess of cationic charge is a starting material for the method according to the invention and is produced prior to use in the method according to the invention.

Additional polyelectrolyte complexes can be formed via a complex formation
between the polyelectrolyte complex A, and an anionic polyelectrolyte and/or an anionic polyelectrolyte mixture and/or a polyelectrolyte complex with an excess of anionic charges and can cover the polyelectrolyte complex A at least partially, essentially completely, or completely; and/or
between the at least one hydrolysis-stable and alkali-resistant cationic polyelectrolyte and/or hydrolysis-stable and alkali-resistant cationic polyelectrolyte mixture and an anionic polyelectrolyte and/or an anionic polyelectrolyte mixture to form a water-soluble polyelectrolyte complex with an excess of cationic charges as a (potential) starting material for the method according to the invention; and/or
between the at least one hydrolysis-stable and alkali-resistant cationic polyelectrolyte and/or hydrolysis-stable and alkali-resistant cationic polyelectrolyte mixture and an anionic polyelectrolyte and/or an anionic polyelectrolyte mixture to form a water-soluble polyelectrolyte complex with an excess of anionic charges as a (potential) starting material for the method according to the invention.

The glass fiber surfaces at least partially covered with the polyelectrolyte complex A according to the invention are at least partially covered with at least one additional (co)polymer and coupled via ionic and/or covalent bonds. The preferably complete coverage with at least one additional (co)polymer can occur on the individual glass fiber, and preferably on glass fibers in a glass fiber bundle/glass fiber roving, via the attachment of a hydrolysis-stable and alkali-resistant (co)polymer or of a hydrolysis-stable and alkali-resistant (co)polymer mixture having functional groups which are capable of a coupling reaction via covalent bonds with the surface of the polyelectrolyte A, through a materially bonded, at least partially, advantageously complete, sheathing/covering of the surface of the polyelectrolyte complex A or of the glass fiber bundle/glass fiber roving.

The sheathing/covering of the glass fibers or of the glass fiber roving can advantageously occur using at least one additional layer, whereby an alkali-resistant reinforcing material is present/created.

It is essential to the invention that, through the present solution, even the surface of glass fibers that are not alkali-resistant is, through an at least partial, advantageously as complete as possible or complete, coverage by a polyelectrolyte I and at least one additional (co)polymer that is coupled to the glass fiber surface via ionic and/or covalent bonds and in a materially bonded manner, essentially completely protected at least against alkaline attack caused by the concrete matrix environment, and that processing-stable and easy-to-handle reinforcing materials for textile concrete exist and can be produced.

Even though an alkaline attack can occur locally at glass fiber ends created by breaking or cutting/chopping and/or at surfaces that have been locally damaged by handling, this attack is only limited to these points and does not move further along the fiber surface, since the covering on the glass fiber surface is coupled in a materially bonded manner via ionic and/or covalent bonds, so that full-length damage cannot take place in the glass fiber bundle/glass roving modified in such a manner.

A material bond of this type according to the invention between the glass fiber surface and a sheathing/covering is not known according the prior art and also does not exist for the known commercially available sized glass fibers, even where they have subsequently been further surface-coated in a commercial manner.

As is sufficiently known from the prior art, after the covering from the dispersion the sizing material is only present such that it is adsorbed locally, that is, distributed at points, on the glass fiber surface during the glass fiber production, since a covering on the glass fiber can therefore take place virtually only in a localized manner via the sizing material points, that is, at points/locally and not across the entire area, and also not in a materially bonded manner. In addition, the commercial sizing material components that can be applied from a water dispersion are at least partially swellable, whereby a reduction of the mechanical cohesiveness between the glass fiber surface and the sizing material occurs. With exposure to moisture and alkali, and during the indiffusion of moisture and alkaline agent(s) into the interface between the glass fiber surface and the swollen layer or other coating material, a reaction with the glass fiber surface occurs and, over time, results in damage to the glass fiber, and therefore in the weakening of the reinforcing effect.

The alkali resistance of the otherwise non-alkali-resistant glass fiber is achieved through the impermeable, materially bonded sheathing/covering with the most complete possible coverage of the glass fiber surface according to the invention, without loose and/or swellable structures and/or capillaries and/or hollow spaces for the diffusion of moisture and/or dissolved alkaline agents into the boundary layer in the direction of the glass fiber surface.

It has proven advantageous if the impermeable, materially bonded sheathing/covering with the most complete possible coverage of the glass fiber surface according to the invention comprises, at the outer surface that interacts with the concrete material, functional and/or polar groups as textile concrete reinforcing material such as for example carboxylic acid groups and/or carboxamide groups and/or sulfonic acid groups and/or sulfonamide groups and/or phosphoric acid groups and/or phosphonic acid and/or urea groups and/or urethane groups and/or hydroxy groups and/or amino groups and/or derivatives thereof with functional and/or polar groups of this fiber composite material coupled via spacer chains, which functional and/or polar groups promote the interactions in the textile concrete in a further reinforcing manner.

Advantageously, the impermeable, materially bonded sheathing/covering with the most complete possible coverage on the anionic glass fiber surface according to the invention acts as a type of buffer so that a potential alkaline attack is also attenuated, and is thus chemically weakened.

Thermosetting and/or thermoplastic (co)polymers can be used as additional (co)polymers. Polyester resins (UP resins), vinyl ester resins and epoxy resins, for example, can be present and used as thermosetting (co)polymers. Polyurethane, polyolefins, such as polyethylene or polypropylene for example, and PVC can be used as thermoplastic (co)polymers, for example, wherein the polyolefins, having been modified with comonomers such as (meth)acrylic acid derivatives and/or maleic anhydride for example, can be used as copolymers and/or grafted copolymer.

The (co)polymer can also be an anionic polyelectrolyte (mixture) or polyelectrolyte complex with an excess of anionic charges, but is preferably also one or more polymers which envelop the modified glass fiber and/or the glass fiber strand.

The glass fibers surface-modified according to the invention can, using an additional chemical modification reaction, be reacted with one or more low-molecular-weight reagent(s) via addition reactions and/or substitution reactions at the surface, and can be functionalized and/or coated and/or coated with oligomers and/or polymers with reactive functional groups for coupling with the glass fibers surface-modified according to the invention via a (melt) reaction at the surface, preferably as glass fiber roving, and can be further modified into a textile concrete reinforcing material during processing.

The (further) processing of the glass fibers surface-modified according to the invention preferably takes place as glass fiber roving in the known pultrusion method or by sheathing with a thermoplastic to form a textile concrete reinforcing material, wherein the coupling via reaction to form material bonds is preferred.

The surface modification and encapsulation of the glass fiber roving/glass fiber bundle by applying thermoplastic or thermosetting polymer preferably takes place directly on the glass fibers surface-modified according to the invention.

The surface modification and encapsulation of the glass fibers and of the glass fiber roving/glass fiber bundle with a thermosetting polymer can take place via resin impregnation in the pultrusion process, for which preferably epoxy resin, vinyl ester resin, polyester resin (UP resin) or polyurethane resin are used and, depending on the resin type and method for producing the textile concrete reinforcing materials, are cured or partially cured. At least one additional (protective) layer of thermosetting and/or preferably thermoplastic polymer, such as for example polyurethane (TPU) or polyolefin grafted with maleic anhydride and preferably polypropylene grafted with maleic anhydride, can advantageously be applied to this thermoset layer for protection against an alkaline attack of the glass fibers of the glass fiber roving/glass fiber bundle, wherein this layer is preferably present such that it is chemically coupled and materially bonded with the thermoset layer.

A further surface modification and encapsulation of the glass fiber roving/glass fiber bundle with preferably a thermoplastic polymer can take place via a sheathing of the glass fibers modified in such a manner as glass fiber roving/glass fiber bundle, for which for example polyurethane (TPU) or polyolefin, such as polyethylene or polypropylene for example, and preferably polyolefin grafted with maleic anhydride and particularly preferably polypropylene grafted with maleic anhydride, or polyamide, such as PA6, PA66 or PA12 for example, is preferably applied as a thermoplastic polymer to the glass fiber bundle for protection against an alkaline attack of the glass fiber, wherein this thermoplastic polymer layer is preferably present such that it is in contact, in a chemically coupled and materially bonded manner, with the glass fibers surface-modified according to the invention or the glass fiber roving/glass fiber bundle having the glass fibers surface-modified according to the invention, and this material is further processed into a reinforcing strand or a tape.

The qualitative novelty, and thus the patent-relevant/inventive difference over the reinforcing materials produced commercially, for example via the pultrusion method, is that no sizing material (dispersion(s)) is/are used for the glass fiber surface modification, and that instead glass fibers surface-modified according to the invention are present with a polyelectrolyte complex A and a covering with at least one additional (co)polymer.

The commercially produced glass fiber materials thus comprise sized glass fibers in which the glass fibers only form a surface coating and a bond at the surface in the local sizing material regions, and it is therefore not possible for a consistent material bond to exist between the glass fiber surface and the sizing material.

Since a material bond of a protective layer to the glass fiber is thus not present, the commercially sized glass fibers with the swellable sizing material regions therefore cannot provide the glass fiber with sufficient protection against the alkaline/corrosive attack in concrete.

Sizing materials or sizing material mixtures according to the prior art are composed of a plurality of substances which in some cases contain specific silanes as adhesion promoting substances. These silanes promote a chemical bond between the glass fiber and sizing material via a reaction with the glass fiber surface; however, since the bond has only formed locally in regions and also not in a materially bonded manner on the glass fiber surface, the silanes also cannot constitute sufficient protection for the sized glass fibers.

As is known, the silanes in sizing material dispersions, which silanes in most cases are used as alkoxysilane, are used in an aqueous sizing material dispersion that is not adequately stable for the duration of the application and changes depending on the ambient conditions (such as for example temperature, pH, concentration, etc.). The changes occur via reactions with one another, for example, also with Si—O—Si bonds being formed; in other words: The silanes condense with one another and possibly also with sizing material (components) and are thus chemically altered as sizing material (component). After application to the glass fiber surface of such sizing material or sizing material mixtures that alter over time, which material or mixtures do not form a closed, materially bonded surface film, the glass fibers are wound into a roving. As a result of the winding, the glass fibers in the roving strand easily become “stuck” to one another, which in many respects is also desirable for further handling. The roving strand is then usually also dried. In direct glass fiber 1/sizing material 1-sizing material 2/glass fiber 2 contact, the local “sticking” taking place between glass fibers and sizing material components has the effect that, during the unwinding of the glass fibers from the glass fiber roving and during the further processing, a “tearing-away of sizing material components” from the glass fiber surfaces among one another occurs, whereby additional imperfections develop on the glass fiber surfaces.

In SEM images (as FIG. 1 and FIG. 2 also show), primarily unmodified/“naked” glass fiber surfaces are visible with isolated sizing material points or points with “sizing material blobs.”

By contrast, the glass fibers surface-modified according to the invention form, via the polyelectrolyte complex A and the additional (co)polymers that are chemically coupled directly to the glass fiber surface via ionic and/or covalent bonds with the polyelectrolyte complex A, a stable material bond across the full area without capillary gaps and/or hollow spaces for the (in)diffusion of (glass-)corrosive substances/media into the boundary layer or boundary layer region, so that no weakening of the glass fiber reinforcing effect in the composite can occur via a corrosive/alkaline attack by the calcium hydroxide released during the cement reaction, and therefore no damage to the glass fiber surface can occur; that is, an alkaline attack thus does not occur in the textile concrete.

The surface-modified glass fibers according to the invention are produced according to the invention in that a hydrolysis-stable and alkali-resistant cationic polyelectrolyte and/or a hydrolysis-stable and alkali-resistant cationic polyelectrolyte mixture and/or a hydrolysis-stable and alkali-resistant polyelectrolyte complex with an excess of cationic charges is applied from an aqueous solution at a concentration of maximally 5 wt % to the glass fiber surfaces in an at least partially covering manner during or after the production of glass fibers, wherein hydrolysis-stable and alkali-resistant cationic polyelectrolytes and/or hydrolysis-stable and alkali-resistant cationic polyelectrolyte mixtures with a molecular weight under 50,000 dalton and/or a hydrolysis-stable and alkali-resistant polyelectrolyte complex with an excess of cationic charges are used, and at least one additional (co)polymer is subsequently applied in an at least partially covering manner to the hydrolysis-stable and alkali-resistant polyelectrolyte complex A created on the glass surface.

Polyelectrolytes which are not subsequently alkylated and/or acylated and/or sulfamidated after production are thereby advantageously used as hydrolysis-stable and alkali-resistant cationic polyelectrolytes, or polyelectrolyte mixtures that are not subsequently alkylated and/or acylated and/or sulfamidated after production are advantageously used as hydrolysis-stable and alkali-resistant cationic polyelectrolyte mixtures.

The following can advantageously be present as hydrolysis-stable and alkali-resistant, unmodified cationic polyelectrolyte or as hydrolysis-stable and alkali-resistant, unmodified cationic polyelectrolyte mixture, as a pure substance or substances or in a mixture, preferably dissolved in water:
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

The list recites available/commercial and easily synthetically producible cationic polyelectrolytes, but is not based on completeness in respect of the possible and usable cationic polyelectrolytes or cationic polyelectrolyte mixtures.

The following are preferably used as unmodified cationic polyelectrolytes or unmodified cationic polyelectrolyte mixtures: polyethyleneimine and/or polyallylamine and/or poly(amide-amine) and/or cationic maleimide copolymers. However, modified cationic polyelectrolytes or cationic polyelectrolyte mixtures can also be used.

The use of strong cationic polyelectrolytes with permanent charges, such as the polyDADMAC with quaternary ammonium groups for example, can occur independent of the pH.

If weak cationic polyelectrolytes are used which carry only primary and/or secondary and/or tertiary amino groups, that is, which have permanent charges not independent of the pH, the process involves an addition of acid, preferably in the weakly acidic range from pH 4 to 6. Via conformation of the dissolved polycations through a repulsion of the identically charged groups, that is, of the generated ammonium groups, a development of the cationic polyelectrolyte macromolecule occurs, whereby a more effective attachment to the glass fiber surface as a weak anionic polyelectrolyte is achieved. The utilization of the polyelectrolyte effect is important for a most optimal and permanent possible attachment of polycations to the glass fiber surfaces as polyanionic solid material surfaces, for example. Extended polycations adsorb as thin films onto the oppositely charged solid material surfaces.

The hydrolysis-stable and alkali-resistant cationic polyelectrolytes and/or hydrolysis-stable and alkali-resistant cationic polyelectrolyte mixtures and/or hydrolysis-stable and alkali-resistant polyelectrolyte complexes with an excess of cationic charges are thereby used at a concentration of maximally 5 wt %, advantageously in water or in water with the addition of acid, such as carboxylic acid, for example formic acid and/or acetic acid, and/or mineral acid, without additional sizing material or sizing material components and/or silanes.

Advantageously, hydrolysis-stable and alkali-resistant cationic polyelectrolytes which are not subsequently alkylated and/or acylated and/or sulfamidated after production and/or hydrolysis-stable and alkali-resistant cationic polyelectrolyte mixtures that are not subsequently alkylated and/or acylated and/or sulfamidated after production are used at a concentration of <2 wt %, and particularly preferably at ≤0.8 wt %.

In the production according to the invention of the surface-modified glass fibers according to the invention, hydrolysis-stable, preferably unmodified, alkali-resistant cationic polyelectrolytes or hydrolysis-stable, preferably unmodified, alkali-resistant cationic polyelectrolyte mixtures are used at a concentration of maximally 5 wt %, advantageously at a concentration of <2 wt %, and particularly preferably at a concentration of ≤0.8 wt %, wherein the concentration is respectively set, that is, optimized, depending on the type of the hydrolysis-stable, preferably unmodified, alkali-resistant cationic polyelectrolyte or hydrolysis-stable, preferably unmodified, alkali-resistant cationic polyelectrolyte mixture, on the charge density in the macromolecule, on the type of cationic group (primary, secondary, tertiary amino group or quaternary ammonium group), on the degree of branching, and on the molecular weight, which is possible for the ordinarily skilled artisan in a few experiments. Furthermore, the setting of the concentration of hydrolysis-stable, preferably unmodified, alkali-resistant cationic polyelectrolyte or hydrolysis-stable, preferably unmodified, alkali-resistant cationic polyelectrolyte mixture is also dependent on whether the surface modification according to the invention is carried out directly during the glass fiber production process and/or afterwards, that is, downstream. The setting of the concentration is adapted to the respective process, wherein an overcharging within the meaning of polyelectrolyte chemistry due to concentrations that are too high is to be avoided. An overcharging is present or takes place as a result of concentrations that are too high where the packing or coverage density on the glass fiber surface is too high and the cationic polyelectrolyte molecules cannot arrange themselves on the glass fiber surface in the most optimal manner possible. In an aqueous medium, a rearrangement towards optimal coverage density then occurs depending on the time, the pH, the type of salt or salt mixture added, as well as the salt concentration and temperature, with the excessively attached cationic polyelectrolyte molecules thereby being (very) slowly released.

The covering of the glass fiber surface with hydrolysis-stable, preferably unmodified, alkali-resistant cationic polyelectrolyte or hydrolysis-stable, preferably unmodified, alkali-resistant cationic polyelectrolyte mixture takes place in water or in water with a solvent additive and/or acid additive, for example, one or more carboxylic acids such as formic acid and/or acetic acid for example, and/or mineral acids. It is thereby particularly advantageous that the use of sizing material or sizing material components such as silanes can be completely omitted for the production and further processing of the modified glass fiber surfaces according to the invention, but glass fiber surfaces modified with sizing material can also be subsequently modified according to the invention.

According to the invention, a modified glass fiber surface was discovered which, in contrast to the statement in DE 2 315 242, Example 54, exhibits very good adhesion to the additional materials that can subsequently be applied, and a composite material with very good adhesion can thus be produced and provided.

As modified hydrolysis-stable and alkali-resistant cationic polyelectrolyte and/or a hydrolysis-stable and alkali-resistant cationic polyelectrolyte mixture can also be used that is partially alkylated and/or acylated and/or reacted with carboxylic acid derivatives and/or sulfamidated in a subsequent reaction following production, and is thus equipped with a substituent having reactive and/or activatable groups for a coupling reaction, which polyelectrolyte and/or polyelectrolyte mixture is then, having the reactive and/or activatable groups of the covalently coupled substituent, reacted with additional materials to form a composite material via at least one functional group and/or via at least one olefinically unsaturated double bond without crosslinking of the hydrolysis-stable and alkali-resistant cationic polyelectrolyte or of the hydrolysis-stable and alkali-resistant cationic polyelectrolyte mixture.

Within the scope of the present invention, polycations or polycation mixtures are to be understood and used as unmodified cationic polyelectrolytes, which polycations or polycation mixtures are used such that, after production, they are modified neither in a subsequent reaction nor chemically modified with low-molecular-weight and/or oligomeric and/or polymeric agents, that is, alkylated (for example, through haloalkyl derivatives and/or (epi)halohydrin compounds and/or epoxy compounds or derivatives) and/or acylated (for example, through agent(s) with one or more carboxylic acid groups and/or carboxylic acid halide groups and/or carboxylic anhydride groups and/or carboxylic acid ester groups and/or diketenes and/or diketene-acetone adduct) and/or reacted with carboxylic acid derivatives, that is, quasi-acylated (for example, through agent(s) with one or more isocyanate groups and/or urethane groups and/or carbodiimide groups and/or uretdione groups and/or allophanate groups and/or biuret groups and/or carbonate groups) and/or sulfamidated. In water, the cationic polyelectrolyte or the cationic polyelectrolyte mixture is used in a dissolved state, preferably as an ammonium compound; that is, if the amino groups of the cationic polyelectrolyte or cationic polyelectrolyte mixture are present as primary and/or secondary and/or tertiary amino groups, they are at least partially converted to the ammonium form via an addition of acid.

An advantageously partial alkylation of the hydrolysis-stable and alkali-resistant cationic polyelectrolyte or of the hydrolysis-stable and alkali-resistant cationic polyelectrolyte mixture occurs, with substituents having reactive groups thereby being introduced, through haloalkyl derivatives and/or (epi)halohydrin compounds and/or epoxy compounds and/or compounds which enter into a Michael-analogous addition, advantageously such as acrylates and/or acrylonitrile with amines.

The partial acylation of the hydrolysis-stable and alkali-resistant cationic polyelectrolyte or of the hydrolysis-stable and alkali-resistant cationic polyelectrolyte mixture can be achieved, advantageously with substituents having reactive groups also thereby being introduced, through carboxylic acids and/or carboxylic acid halides and/or carboxylic acid anhydrides and/or carboxylic acid esters and/or diketenes, or if a quasi-acylation is achieved through isocyanates and/or urethanes and/or carbodiimides and/or uretdiones and/or allophanates and/or biurets and/or carbonates.

It is advantageous if the hydrolysis-stable and alkali-resistant cationic polyelectrolytes and/or hydrolysis-stable and alkali-resistant cationic polyelectrolyte mixtures used are used at a molecular weight under 50,000 dalton, preferably in the range between 400 dalton and 10,000 dalton.

For the cationic polyelectrolytes synthetically produced via polymerization and/or polycondensation, molecular weights of <50,000 Da (dalton), and more advantageously molecular weights of <10.000 dalton (Da), have proven advantageous, wherein the optimal range of the molecular weight for each specific cationic polyelectrolyte must be determined in experiments. Molecular weights that are too high have proven unfavorable, since the optimal attachment and coverage of the glass fiber surface is not always free of problems with these cationic polyelectrolytes. With branched polyethyleneimine, for example, the molecular weight range from 400 dalton to 10,000 Da has proven beneficial.

According to the invention, the surface-modified glass fibers are advantageously also produced in that the hydrolysis-stable and alkali-resistant cationic polyelectrolytes and/or the hydrolysis-stable and alkali-resistant cationic polyelectrolyte mixture and/or the hydrolysis-stable and alkali-resistant polyelectrolyte complexes with an excess of cationic charges are used such that they are dissolved in water, preferably as an ammonium compound, wherein in the case of primary and/or secondary and/or tertiary amino groups carboxylic acid(s) and/or mineral acid(s) are added to the aqueous solution to convert the amino groups into the ammonium form.

Advantageously, glass fiber surfaces modified according to the invention as polyelectrolyte A that are at least partially, and preferably completely, covered at least with a hydrolysis-stable and alkali-resistant cationic polyelectrolyte or a hydrolysis-stable and alkali-resistant cationic polyelectrolyte mixture and/or a hydrolysis-stable and alkali-resistant polyelectrolyte complex with an excess of cationic charges can be, directly following the production and coating/surface modification thereof and/or at a later point, reacted with additional materials, with chemically ionic and/or covalent bonds thereby being formed.

This can take place, for example, if a hydrolysis-stable and alkali-resistant anionic polyelectrolyte and/or a hydrolysis-stable and alkali-resistant anionic polyelectrolyte mixture and/or a hydrolysis-stable and alkali-resistant polyelectrolyte complex with an excess of anionic charges is coupled to the glass fiber surfaces modified with the polyelectrolyte complex A according to the invention.

This can take place, for example, if the glass fiber surfaces modified in such a manner are wound and/or intermediately stored as roving and are subsequently reacted with additional materials, with chemically covalent bonds thereby being formed.

It is thereby particularly advantageous if the hydrolysis-stable and alkali-resistant cationic polyelectrolyte or the hydrolysis-stable and alkali-resistant cationic polyelectrolyte mixture and/or the hydrolysis-stable and alkali-resistant polyelectrolyte complex with an excess of cationic charges comprises on the glass fiber surface as polyelectrolyte complex A or after a further modification with additional polyelectrolyte mixture(s) and/or polyelectrolyte complexes, reactive and/or activatable groups in the form of functional groups and/or olefinically unsaturated double bonds that are reacted with functionalities of the additional materials, with chemically covalent bonds thereby being formed.

The modification of the glass fiber surface according to the invention can advantageously also be carried out on commercially produced and sized glass fiber surfaces, or glass fiber surfaces without sizing material and silane, in that an aqueous solution with a concentration of maximally 5 wt % of a hydrolysis-stable and alkali-resistant cationic polyelectrolyte and/or of a hydrolysis-stable and alkali-resistant cationic polyelectrolyte mixture and/or of a hydrolysis-stable and alkali-resistant polyelectrolyte complex with an excess of cationic charges is applied in an at least partially covering manner, wherein cationic polyelectrolytes or cationic polyelectrolyte mixtures with a molecular weight under 50,000 dalton are used.

The treatment of wound glass fibers preferably produced while still in a moist state, without or with a water-soluble lubricant, such as a surfactant or surfactant mixture and/or glycerin and/or polyethylene glycol and/or polypropylene glycol for example, in order to improve the sliding properties, which glass fibers for the surface modification, preferably in an unwound state, are pulled through a bath or stored in a bath, for example in a bath with a solution of hydrolysis-stable, preferably unmodified, alkali-resistant cationic polyelectrolyte or of a hydrolysis-stable, preferably unmodified, alkali-resistant cationic polyelectrolyte mixture and/or of a dissolved hydrolysis-stable and alkali-resistant polyelectrolyte complex with an excess of cationic charges, previously produced from a cationic polyelectrolyte (mixture) and an anionic polyelectrolyte (mixture) can, for example, be re-treated, wherein if water-soluble lubricants are used, these lubricants then dissolve and the cationic polyelectrolyte or cationic polyelectrolyte mixture and/or dissolved polyelectrolyte complex with an excess of cationic charges attach to the glass fiber surface or these lubricants are replaced by the cationic agents.

Within the scope of the present invention, cationic agents are to be understood as meaning the cationic polyelectrolytes used and present on the glass surface and/or the cationic polyelectrolyte mixture and/or the polyelectrolyte complex with an excess of cationic charges.

Surprisingly, contrary to the statement from DE 2 315 245, Example 54, a complete and very stable covering of the glass fiber surfaces was verified via pH-dependent zetapotential measurements for the cationic polyelectrolytes polyallylamine, polyethyleneimine (branched), poly(amide-amine), cationic copolymaleimide (produced from an alternating propene maleic anhydride copolymer, reacted with N,N-dimethylamino-n-propylamine and imidized) and a 1:1 mixture of polyethyleneimine (branched) and polyallylamine as well as polyDADMAC depending on the type of polycation (mixture), the charge density, the degree of branching, and the molecular weight. As a further verification method for cationic agents with amino groups, the known addition reaction of the amino group-sensitive fluorescence marker fluorescamine was used for detection. Even an intensive washing with diluted acids or bases or a reflux heating or an extraction over several hours in water with diluted acetic acid changed nothing about the analytical statements that the surface modification is present with optimal coverage.

The hydrolysis-stable, preferably unmodified, alkali-resistant cationic polyelectrolytes or hydrolysis-stable, preferably unmodified, alkali-resistant cationic polyelectrolyte mixtures form with the glass fiber surface a hydrolytically stable and alkali-resistant polyelectrolyte complex A, which can be verified in pH-dependent zetapotential measurements by the stable position of the isoelectric point (at which the zetapotential=0). The position of the isoelectric point and the shape of the zetapotential curves before and after the washing or extracting are virtually congruent, which verifies the stability of this surface modification on the glass fibers.

Compared to untreated glass fibers and commercial glass fibers treated with sizing material, both the position of the isoelectric point and also the shape of the zetapotential curves change with the surface-treated glass fibers according to the invention.

Depending on the hydrolysis-stable and alkali-resistant cationic agents used, and above all depending on the degree of branching at pH levels <7, a largely mono(macro)molecular coverage of the glass fiber surface with cationic agents in the form of a thin film is achieved.

It has not yet been possible to achieve or verify a complete separation/elimination of the hydrolysis-stable cationic agents applied according to the invention from the glass fiber surface.

A concentration of cationic agents that is too high or a pH >7 with weak cationic agents should be avoided, since in this case the attachment of the cationic agents to the glass surface does not proceed in an optimal manner, that is, the coverage is not optimal, and forms what is referred to as an “asymmetrical polyelectrolyte complex” with the glass surface.

The term “asymmetrical polyelectrolyte complex” is understood as meaning a situation where a higher concentration of agents with cationic charges than agents with anionic charges is present in the polyelectrolyte complex and “asymmetrical polyelectrolyte complexes” that can be altered and stabilized by rearrangement are thus formed. In the case presently under discussion, a concentration of agents with cationic charges that is too high compared to the anionic glass fiber surface would be present, and would thus form an asymmetrical polyelectrolyte as polyelectrolyte complex A.

Where concentrations of cationic agents are too high, the equilibrium reaction between the glass surface and cationic agents can, for example, be shifted towards a stable surface covering by a (subsequent) storage in water or a boiling or extracting with water, which can be used or utilized as a later practical corrective for an incorrect concentration of cationic agents and therefore deficient surface modification.

Via rearrangement reactions of the cationic agents at the glass fiber surface depending on the time, temperature, pH and salt concentration, a stabilization of the glass fiber surface to be modified with cationic agents towards an optimal and stable coverage is achieved. In a few trials, the ordinarily skilled artisan can determine the technological window, that is, the sufficiently optimal concentration, for the respective cationic agents in order to avoid a concentration that is too high and a re-treatment.

The glass fiber surfaces modified according to the invention can be further modified directly during the glass fiber production process or at a later point. The glass fibers modified in such a manner can be further processed into a reinforcing material for textile concrete directly following the glass fiber production process or at a later point.

Glass fibers can be modified according to the invention directly after the glass fiber production, or can even first be wound as glass fiber roving and stored intermediately, for example, and then, having been modified according to the invention, be further processed into a reinforcing material for textile concrete.

After the production of the glass fibers and the surface modification into polyelectrolyte A according to the invention, the existing surface modification can be further modified with an additional polyelectrolyte complex via an attachment of hydrolysis-stable and alkali-resistant anionic polyelectrolytes or hydrolysis-stable and alkali-resistant anionic polyelectrolyte mixtures. This is primarily necessary where cationic polyelectrolytes with quaternary ammonium groups are used, so that material bonds can be produced through coupling reactions via the formation of an additional stable polyelectrolyte complex, wherein the attached hydrolysis-stable and alkali-resistant anionic polyelectrolytes or hydrolysis-stable and alkali-resistant anionic polyelectrolyte mixtures have reactive and/or activatable groups in the form of functional groups and/or olefinically unsaturated double bonds for coupling reactions, and during the sheathing/covering with additional (co)polymers in another subsequent process for modifying and coating the glass fibers or the glass fiber roving, for example, in the pultrusion method.

The following are used, for example, as anionic polyelectrolytes or anionic polyelectrolyte mixtures, preferably dissolved in water:
(meth)acrylic acid copolymers which are present without and/or with at least one additional functional group that is different from carboxylic acid and was introduced via the copolymerization, and/or which are present with at least one additional functional group that is different from carboxylic acid and/or with at least one olefinically unsaturated double bond that are coupled via a polymer-analogous reaction/modification of the (meth)acrylic acid group, and which are preferably water-soluble, and/or
modified maleic acid (anhydride) copolymers which are preferably partially or completely present in the acid and/or monoester and/or monoamide and/or water-soluble imide form, and/or which are present without and/or with residual anhydride groups, and/or which are present without and/or with at least one additional functional group that was introduced via the copolymerization, and/or which are present with at least one additional functional group and/or with at least one olefinically unsaturated double bond that are coupled via a polymer-analogous reaction/modification of preferably maleic acid (anhydride) groups, and which are preferably water-soluble, and/or
modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional functional group that was introduced via the copolymerization, and/or which are present with at least one additional functional group and/or with at least one olefinically unsaturated double bond that are coupled via a polymer-analogous reaction/modification of preferably itaconic acid (anhydride) groups, and which are preferably water-soluble, and/or
modified fumaric acid copolymers which are preferably present in the acid and/or monoester and/or monoamide form, and/or which are present without and/or with at least one additional functional group that was introduced via the copolymerization, and/or which are present with at least one additional functional group and/or at least one olefinically unsaturated double bond that are coupled via a polymer-analogous reaction/modification of preferably fumaric acid groups, and which are preferably water-soluble, and/or
anionically modified (meth)acrylamide (co)polymers which are present without and/or with at least one additional functional group that was introduced via the copolymerization, and/or which are present with at least one additional functional group and/or with at least one olefinically unsaturated double bond that are coupled via a polymer-analogous reaction/modification of the preferably (meth)acrylamide group, and which are preferably water-soluble, and/or
sulfonic acid (co)polymers, such as for example styrenesulfonic acid (co)polymers and/or vinylsulfonic acid (co)polymers in acid and/or salt form, which are present with at least one additional reactive functional group for coupling reactions that was introduced via the copolymerization, and/or which are present with at least one additional reactive functional group for coupling reactions and/or at least one olefinically unsaturated double bond for radical coupling reactions that are coupled via a polymer-analogous reaction/modification of sulfonic acid groups, such as for example via sulfonic acid amide groups, and which are preferably water-soluble, and/or
(co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive functional group for coupling reactions that was introduced via the copolymerization, and/or which are present with at least one additional reactive functional group for coupling reactions and/or with at least one olefinically unsaturated double bond for radical coupling reactions that are coupled via a polymer-analogous reaction/modification of the (co)polymer and which are preferably water-soluble.

The selection of the agents and the execution of the further processing, into the composite materials according to the invention, of the glass fiber surfaces modified with the hydrolysis-stable and alkali-resistant cationic polyelectrolytes or hydrolysis-stable and alkali-resistant cationic polyelectrolyte mixtures and/or with the hydrolysis-stable and alkali-resistant polyelectrolyte complex with an excess of cationic charges, which modified glass fiber surfaces are chemically coupled with the glass fiber surface via ionic bonds as polyelectrolyte complex A, and/or of the glass fiber surfaces modified with hydrolysis-stable and alkali-resistant anionic polyelectrolytes or hydrolysis-stable and alkali-resistant anionic polyelectrolyte mixtures and/or with the hydrolysis-stable and alkali-resistant polyelectrolyte complex with an excess of anionic charges as an additional polyelectrolyte complex, takes place according to the chemical knowledge common for the ordinarily skilled artisan and is explained in greater detail in the examples using a few specific embodiments.

The use of cationic polyelectrolytes and/or cationic polyelectrolyte mixtures that have, in a manner similar to the prior art, been modified prior to the application during the glass fiber production process and do not have any silane groups, and which are modified/equipped with specific functional groups for reaction and/or compatibilization with a matrix material or at least one component of the matrix material and/or are equipped with functions, such as those for improving the sliding properties via amidation with fatty acids for example, has proven less effective in terms of the attachment and optimal coverage density on the glass fiber surface and with regard to the reinforcing effect, since in this case the direct attachment to and interaction with the glass fiber surface, mostly interfered with by steric effects, is impaired.

The subsequent chemical modification of the glass fiber surface modified with the hydrolysis-stable and alkali-resistant cationic polyelectrolytes or hydrolysis-stable and alkali-resistant cationic polyelectrolyte mixtures and/or the hydrolysis-stable and alkali-resistant polyelectrolyte complex with an excess of cationic charges and the subsequent sheathing/covering with additional (co)polymers is considered to be the optimal variant based on experimental analyses.

In the production of reinforcing materials with a thermosetting sheathing/protective layer for textile concrete use, the dry, modified glass fibers are, as hydrolysis-stable and alkali-resistant polyelectrolyte complex A with amino groups and/or ammonium groups at the surface, in the first stage reacted directly in the pultrusion process. The following are used as thermosetting (co)polymers, for example:
epoxy resins or
polyurethane materials (PUR/polyurethane) or
UP resins, vinyl ester resins or SMC resin mixtures, wherein a reactive component having at least one reactive functional group for coupling with amino groups at the glass fiber surface modified as polyelectrolyte A and having at least one olefinically unsaturated double bond for reaction with the unsaturated matrix component(s) (such as for example glycidyl methacrylate (GMA) and/or (meth)acrylic anhydride and/or (meth)acrylic chloride and/or allyl glycidyl ether and/or tetrahydrophthalic anhydride and/or maleic anhydride and/or itaconic anhydride) was added to the UP resin mixture, vinyl ester resin mixture or SMC resin mixture.

In the case of the surface modification of the glass fibers with polyelectrolytes having quaternary ammonium groups that are not capable of chemically reactive, that is, covalent, coupling, as in the case of the poly(diallyldimethylammonium chloride) (polyDADMAC), a specifically modified anionic polyelectrolyte or a specifically modified anionic polyelectrolyte mixture is attached to the polyelectrolyte surface having quaternary ammonium groups and an additional polyelectrolyte complex formed in a second method step for the (re)activation of this polyelectrolyte complex A. The anionic polyelectrolyte or the anionic polyelectrolyte mixture, which can also be modified with specific functional groups and/or olefinically unsaturated double bonds for reaction and/or compatibilization with matrix materials and/or possibly equipped with functions such as those for improving the sliding properties for example, are commercially available on a wide scale, for example as (meth)acrylic acid copolymer derivatives and/or (modified) maleic acid (anhydride) copolymer derivatives and/or (modified) itaconic acid (anhydride) (co)polymer derivatives and/or (modified) fumaric acid copolymer derivatives and/or styrenesulfonic acid (co)polymer derivatives and/or anionically equipped acrylamide (co)polymer derivatives. The ordinarily skilled artisan can in this case draw on a plurality of commercial products that are not individually listed here.

The essential feature of this invention is that the glass fiber surface is in the first step equipped with a most mono(macro)molecular possible layer of a hydrolysis-stable and alkali-resistant cationic polyelectrolyte and/or of a hydrolysis-stable and alkali-resistant cationic polyelectrolyte mixture and or a hydrolysis-stable and alkali-resistant polyelectrolyte complex with an excess of cationic charges with a layer thickness on the nanometer scale without the use of sizing material and/or silane, and that after the (polyelectrolyte) complex formation process at the glass fiber surface a hydrolysis-stable and alkali-resistant polyelectrolyte complex A is present such that it has been produced and coupled to the glass surface by means of ionic bonds, wherein at least one additional (co)polymer at least partially covers the polyelectrolyte complex A and is coupled with the polyelectrolyte complex A via ionic and/or preferably covalent bonds.

Surprisingly, it was also discovered that the hydrolysis-stable and alkali-resistant cationic polyelectrolytes and/or hydrolysis-stable and alkali-resistant cationic polyelectrolyte mixtures attached to the glass fiber surface form a very stable polyelectrolyte complex A, and that the hydrolysis-stable and alkali-resistant cationic polyelectrolytes and/or the hydrolysis-stable and alkali-resistant cationic polyelectrolyte mixtures can no longer be separated from the glass surface by typical dissolving and/or extraction processes.

A partial to virtually complete separation of the hydrolysis-stable and alkali-resistant cationic polyelectrolytes and/or of the hydrolysis-stable and alkali-resistant cationic polyelectrolyte mixtures and/or of the hydrolysis-stable and alkali-resistant polyelectrolyte complex with an excess of cationic charges from the glass fiber surface would only be conceivable with an excess of strong anionic polyelectrolytes and would only be possible in that, in an equilibrium reaction in an aqueous environment, the cationic agents from the glass surface essentially connect to this strong anionic polyelectrolyte and thus “rearrange” via formation of a separate polyelectrolyte complex in the solution.

Analogously, a weak cationic agent attached to the glass surface can also be partially to completely exchanged for stronger cationic agents having, for example, quaternary ammonium groups if an excess of strong cationic polyelectrolyte or cationic polyelectrolyte mixture is introduced into the exchange reaction.

Within the scope of the present invention, polyelectrolytes are to be understood as meaning water-soluble compounds with a long chain length (polymers) that carry anionic (polyacids) or cationic (polybases) dissociable groups (Wikipedia, German-language keyword “Polyelektrolyte”).

The adsorption of polyelectrolytes of this type onto the glass fiber surface occurs in that dissolved cationic agents are adsorbed onto the oppositely charged anionic glass fiber surface. The adsorption is driven, among other things, by the electrostatic attraction between the charged monomer units of the polyelectrolytes and oppositely charged, dissociated surface groups on the glass fiber surface, for example SiO groups on silicon dioxide surfaces. However, the release of counterions or the formation of hydrogen bonds also enable adsorption. The conformation of the polyelectrolyte in a dissolved state determines the amount of adsorbed substance. Extended polyelectrolyte molecules adsorb onto the surface as thin films (0.2 nm-1 nm), whereas coiled polyelectrolyte molecules form thicker layers (1 nm-8 nm) (Wikipedia, German-language keyword “Polyelektrolyte”).

In contrast to the prior art, a stable, materially bonded surface modification of the glass fibers with a preferably complete degree of coverage of the glass fiber surface is achieved in the first stage prior to the further modification of the glass roving, and stable compounds dissolved in water are used which are not altered during the application. Furthermore, no sizing material mixtures or sizing material dispersions need to be used, nor are silanes absolutely necessary for the coupling with the glass fiber surface, which silanes chemically change in water as a function of time.

With the invention, in contrast to the prior art, even non-alkali-resistant glass fibers such as the more economical E-glass fibers can be used as reinforcing material for textile concrete after the surface modification according to the invention and the materially bonded coating.

The invention is explained below in greater detail with the aid of several exemplary embodiments.

Throughout the examples, the production and modification of glass fibers, specifically as roving (glass fiber bundle), into reinforcing materials for use in textile concrete takes place on an E-glass spinning system on a pilot-plant scale for the spinning and on-line surface modification of glass fibers. The system has sizing stations, which can be used downstream for multi-stage application immediately following the spinning process, and a direct roving winder.

After the cleaning of the sizing station, the tub is filled with an aqueous solution of different hydrolysis-stable, preferably unmodified and alkali-resistant cationic polyelectrolytes and/or of different hydrolysis-stable, preferably unmodified and alkali-resistant cationic polyelectrolyte mixtures. Depending on the draw-off speed, filament yarns of 50 to 200 tex can be spun using the system.

### EXAMPLE 1

In the glass silk spinning system, E-glass fibers with 100 tex are spun and are surface-modified, wound and dried (glass roving material 1) in the “sizing station,” which is filled with an aqueous 1.0% PEI solution as a cationic polyelectrolyte (PEI=polyethyleneimine, Aldrich, Mₙ=10,000).

The pH-dependent zetapotential measurements on the glass fibers treated in such a manner verify the adsorption of PEI at the surface.

The detection of coupled amino groups at the surfaces and verification of the uniform coverage of the glass fibers was conducted using the fluorescamine method.

### EXAMPLE 1A: SURFACE SEALING WITH EPOXY

The dried, surface-modified glass roving material 1 is pulled through an impregnation bath with hot-curing epoxy and is thus impregnated with the epoxy resin for the surface treatment, the excess adherent epoxy is separated off by a routing through rubber rollers and, following the shaping, this epoxy-treated glass fiber roving material is then routed through a heating section in which the material is processed such that it is partially crosslinked into a materially bonded, compact pre-preg strand and, after a cooling section, is wound (pre-preg strand material 1). A materially bonded pre-preg strand material 1 surface-modified with a thicker epoxy resin layer is in this form further processed as reinforcing material for textile concrete as follows: The pre-preg strand material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This pre-preg reinforcing material is cured for 1 hour at 165° C. under moderate pressure, wherein during the consolidation process the partially crosslinked epoxy resin of these strands forms at the intersecting points a bond that is stable for handling. After the cooling, a grid network is available as reinforcing material for use in textile cement.

### EXAMPLE 1B: SURFACE COATING WITH THERMOPLASTIC POLYURETHANE

The pre-preg strand material 1 produced in Example 1a from modified glass fiber roving with an epoxy resin seal is in a second stage routed through a nozzle and coated/enveloped with a melt of thermoplastic polyurethane (TPU). During the coating, in addition to the thermal curing of the partially cured epoxy resin, coupling reactions take place in the interface between the epoxy resin and TPU. With the formation of covalent bonds, the TPU is present such that it is chemically coupled with the epoxy as a material bond. After a cooling section, the TPU strand material 1 is wound.

This TPU strand material 1 is further processed as reinforcing material for textile concrete as follows: The TPU strand material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 30 minutes at 190° C. under moderate pressure, wherein via a fusing of the TPU the strands form at the intersecting points a bond that is stable for handling. After the cooling, this grid network is used as reinforcing material in textile concrete.

### EXAMPLE 1C: SURFACE-COATING WITH POLYPROPYLENE GRAFTED WITH MALEIC ANHYDRIDE

The pre-preg strand material 1 produced in Example 1a is in a second stage routed through a nozzle and coated/enveloped with a melt of polypropylene grafted with maleic anhydride (PP-gMAn). During the coating, in addition to the thermal curing of the partially cured epoxy resin, coupling reactions take place in the interface between the epoxy resin and PP-gMAn. With the formation of covalent bonds, the PP-gMAn is present as a chemical material bond with the epoxy resin. After a cooling section, the PP-gMAn strand material 1 is wound.

This PP-gMAn strand material 1 is further processed as reinforcing material for textile concrete as follows:

The PP-gMAn strand material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 30 minutes at 160° C. under moderate pressure, wherein via a fusing of the PP-gMAn the strands form at the intersecting points a bond that is sufficiently stable for handling. After the cooling, this grid network is used as reinforcing material in textile concrete.

### EXAMPLE 1D: SURFACE SEALING WITH UP RESIN AND COATING WITH PP-GMAN

The dried, surface-modified glass roving material 1 is pulled through an impregnation bath with UP resin, to which 5 mass % glycidyl methacrylate (GMA) was added, and in this manner impregnated with the UP resin for surface treatment. The excess UP resin is separated off by a routing through rubber rollers and, following the shaping, this UP resin-treated glass fiber roving material is then routed through a heating section in which the material is processed such that it is crosslinked into a materially bonded, compact strand and, after a cooling section, is wound.

In a second process step, the strand is routed through a nozzle in which the strand is coated/enveloped with a melt of polypropylene grafted with maleic anhydride (PP-gMAn). During the coating, coupling reactions take place in the interface between the UP resin modified with GMA and the PP-gMAn. With the formation of covalent bonds, the PP-gMAn is present as a chemical material bond with the UP resin surface. After a cooling section, the UP-PP-gMAn strand material 1 is wound.

This UP-PP-gMAn strand material 1 is in this form further processed as reinforcing material for textile concrete as follows:

The UP-PP-gMAn strand material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 20 minutes at 160° C. under moderate pressure, wherein via a fusing of the PP-gMAn the strands form at the intersecting points a bond that is sufficiently stable for handling. After the cooling, this grid network is used as reinforcing material in textile concrete.

### EXAMPLE 1E: SURFACE SEALING WITH PP-GMAN

The dried, surface-modified glass roving material 1 is directly coated with a low-viscosity polypropylene grafted with maleic anhydride (PP-gMAn) in an infiltrative and enveloping manner via pultrusion and processed into a narrow tape. During the infiltration and coating, coupling reactions take place in the interface between the glass fibers of the glass roving material 1 and the PP-gMAn. With the formation of covalent bonds, the PP-gMAn is present as a chemical material bond with the glass fibers via the polyelectrolyte complex A. After a cooling section, the material is wound as narrow PP-gMAn tape material 1.

This PP-gMAn tape material 1 is in this form further processed as reinforcing material for textile concrete as follows:

The PP-gMAn tape material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 15 minutes at 160° C. under moderate pressure, wherein via a fusing of the PP-gMAn the tapes form at the intersecting points a bond that is sufficiently stable for handling. After the cooling, this grid network is used as reinforcing material in textile concrete.

### EXAMPLE 1F: SURFACE SEALING WITH PP-GMAN AND COATING WITH PP

The dried, surface-modified glass roving material 1 is (as in Example 1e) directly coated with a low-viscosity polypropylene grafted with maleic anhydride (PP-gMAn) in an infiltrative and enveloping manner via pultrusion. During the infiltration and coating, coupling reactions take place in the interface between the glass fibers of the glass roving material 1 and the PP-gMAn. With the formation of covalent bonds, the PP-gMAn is present as a chemical material bond with the glass fibers via the polyelectrolyte complex A. In a second coating system, this strand is then routed through a nozzle and enveloped with a viscous PP material, wherein the two polypropylenes fuse in the interface. After a cooling section, the PP-gMAn-PP strand material 1 is wound.

This PP-gMAn-PP strand material 1 is in this form further processed as reinforcing material for textile concrete as follows:

The PP-gMAn-PP strand material 1 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 30 minutes at 170° C. under moderate pressure, wherein via a fusing of the PP-materials of the outer layer the strands form at the intersecting points a bond that is sufficiently stable for handling. After the cooling, this grid network is used as reinforcing material in textile concrete.

### EXAMPLE 2

E-glass fibers with 100 tex are spun in the glass silk spinning system and are surface-modified, wound and dried in the “sizing station,” which is filled with an aqueous 0.25% polyDADMAC solution as a cationic polyelectrolyte (polyDADMAC=poly(diallyldimethylammonium chloride), Aldrich, Mw<100,000, very low-molecular).

The pH-dependent zetapotential measurements on the glass fibers treated in such a manner verify the adsorption of polyDADMAC onto the surface.

Since as a strong cationic polyelectrolyte the polyDADMAC has only quaternary ammonium groups and otherwise no additional olefinically unsaturated double bonds and/or reactive functional groups that are relevant for chemical radical reactions, addition reactions and substitution reactions, direct reactions are not possible. In this case, for further modification, the glass fiber surface-modified with polyDADMAC is treated with an anionic polyelectrolyte that has an additional functional group, which is different from the anionic group, for the chemical coupling and/or compatibilization with the matrix material or at least one component of the matrix material, and a “glass fiber surface/polyDADMAC/anionic polyelectrolyte” polyelectrolyte complex is formed. This modification variant via the polyelectrolyte complex formation process is preferably used for glass fibers surface-modified with polyDADMAC. For this reason, in an apparatus technically analogous to the sizing station, the glass fiber roving surface-modified with polyDADMAC is, via rewinding by means of a roller, in a second stage treated with a 0.5% propene-alt-maleic acid-N,N-dimethylamino-n-propyl-monoamide solution (produced from propene-alt-maleic anhydride via reaction with N,N-dimethylamino-n-propylamine in water at a 1 to 0.4 ratio of anhydride to primary amino group) for the formation of the “glass fiber surface/polyDADMAC/anionic polyelectrolyte” polyelectrolyte complex and is wound and dried (glass roving material 2).

### EXAMPLE 2A: SURFACE SEALING WITH EPOXY AND COATING WITH PA12

The dried, surface-modified glass roving material 2 is pulled through an impregnation bath with hot-curing epoxy and is thus impregnated with the epoxy resin for surface treatment, the excess adherent epoxy is separated off by a routing through rubber rollers and, following the shaping, this epoxy-treated glass fiber roving material is then routed through a heating section in which the material is processed such that it is partially crosslinked into a materially bonded pre-preg strand and, after a cooling section, is wound (pre-preg strand material 2).

In a second stage, this pre-preg strand material 2 is routed through a nozzle and coated/enveloped with a melt of PA12. During the coating, in addition to the thermal curing of the partially cured epoxy resin, coupling reactions take place in the interface between the epoxy resin and PA12.

With the formation of covalent bonds, the PA12 is present such that it is chemically coupled with the epoxy as a material bond. After a cooling section, the PA12 strand material 2 is wound.

This PA12 strand material 2 is further processed as reinforcing material for textile concrete as follows:

The PA12 strand material 2 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 30 minutes at 190° C. under moderate pressure, wherein via a fusing of the PA12 the strands form at the intersecting points a bond that is stable for handling. After the cooling, this grid network is used as reinforcing material in textile concrete.

### EXAMPLE 2B: SURFACE SEALING WITH UP RESIN

The dried, surface-modified glass roving material 2 is pulled through an impregnation bath with UP resin, to which 5 mass % glycidyl methacrylate was added, and in this manner impregnated with the UP resin for surface treatment. The excess adherent UP resin is separated off by a stripper. Following the shaping, this UP resin-treated glass fiber roving material is then routed through a heating section in which the material is processed such that it is partially crosslinked into a materially bonded, compact strand and, after a cooling section, is wound (pre-preg strand material 3).

This pre-preg strand material 3 is further processed as reinforcing material for textile concrete as follows:

The pre-preg strand material 3 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 20 minutes at 180° C. under moderate pressure, wherein during the consolidation process the partially crosslinked UP resin of these strands forms at the intersecting points a bond that is stable for handling. After the cooling, a grid network is available as reinforcing material for use in textile cement.

### EXAMPLE 2C: SURFACE COATING WITH ABS

In a second process step, the pre-preg strand material 3 is routed through a nozzle and sheathed with an ABS melt. During the coating, coupling reactions take place in the interface between the partially crosslinked UP resin and the ABS, and the UP resin continues to cure. With the formation of covalent bonds, the ABS is present as a chemical material bond with the UP resin surface. After a cooling section, the ABS-UP resin strand material 2 is wound.

This ABS-UP resin strand material 2 is further processed as reinforcing material for textile concrete as follows:

The ABS-UP strand material 2 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 15 minutes at 200° C. under moderate pressure, wherein the UP resin of these strands cures and, via a fusing of the ABS, the strands form at the intersecting points a bond that is stable for handling. After the cooling, a grid network is available as reinforcing material for use in textile cement.

### EXAMPLE 3

Analogously to Example 1, E-glass fibers with 150 tex are spun in the glass silk spinning system and are surface-modified and wound (glass roving material 3) in the “sizing station,” which is filled with an aqueous 1.0% PEI/polyallylamine solution as a cationic polyelectrolyte (PEI=polyethyleneimine, Aldrich, Mₙ=10,000, polyallylamine, Aldrich, M_{w}˜15,000; PEI/polyallylamine=2/1).

The pH-dependent zetapotential measurements on the glass fibers treated in such a manner verify the adsorption of PEI/polyallylamine at the surface.

The detection of coupled amino groups at the surfaces and verification of the uniform coverage of the glass fibers was conducted using the fluorescamine method.

### EXAMPLE 3A: SEALING WITH EPOXY AND COATING WITH PA6

The dried, surface-modified glass roving material 3 is pulled through an impregnation bath with hot-curing resin and in this manner impregnated with the epoxy resin for surface treatment. The excess adherent epoxy is separated off by a routing through rubber rollers and, following the shaping, this epoxy-treated glass fiber roving material is then routed through a heating section in which the material is processed such that it is partially crosslinked into a materially bonded, compact pre-preg strand and, after a cooling section, is wound (pre-preg strand material 3).

In a second stage, this pre-preg strand material 3 is routed through a nozzle and coated/enveloped with a melt of PA6. During the coating, in addition to the thermal curing of the partially cured epoxy resin, coupling reactions take place in the interface between the epoxy resin and PA6. With the formation of covalent bonds, the PA6 is present such that it is chemically coupled with the epoxy as a material bond. After a cooling section, the PA6 strand material 3 is wound.

This PA6 strand material 3 is further processed as reinforcing material for textile concrete as follows:

The PA6 strand material 3 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 10 minutes at 230° C. under moderate pressure, wherein via a fusing of the PA6 the strands form at the intersecting points a bond that is stable for handling. After the cooling, this grid network is used as reinforcing material in textile concrete.

### EXAMPLE 3B: SEALING WITH EPOXY AND COATING WITH PE-COAAC IONOMER

The dried, surface-modified glass roving material 3 is (as in Example 3a) processed into a pre-preg strand material 3.

In a second stage, this pre-preg strand material 3 is routed through a nozzle and coated/enveloped with a melt of PE-coAAc ionomer (polyethylene-co-acrylic acid ionomer, Surlyn, DuPont). During the coating, in addition to the thermal curing of the partially cured epoxy resin, coupling reactions take place in the interface between the epoxy resin and PE-coAAc ionomer. With the formation of covalent bonds, the PE-coAAc ionomer is present such that it is chemically coupled with the epoxy as a material bond. After a cooling section, the PE-coAAc strand material 3 is wound.

This PE-coAAc strand material 3 is further processed as reinforcing material for textile concrete as follows:

The PE-coAAc strand material 3 is cut for a demonstrator trial into strands of 0.5 m, and is placed, arranged crosswise at distances of approx. 4 cm, on a 2-mm thick HNBR plate in a heatable press, onto which plate a 0.125-mm thick PTFE shell foil was placed as a separating layer. A second 0.125-mm thick PTFE shell foil, likewise as a separating layer, and a 2-mm thick vulcanized HNBR plate are positioned thereon. This reinforcing material is pressed for 15 minutes at 120° C. under moderate pressure, wherein via a fusing of the PE-coAAc ionomer the strands form at the intersecting points a bond that is stable for handling. After the cooling, this grid network is used as reinforcing material in textile concrete.

1. Surface-modified glass fibers for reinforcing concrete which are at least partially covered at least with a hydrolysis-stable and alkali-resistant cationic polyelectrolyte and/or hydrolysis-stable and alkali-resistant cationic polyelectrolyte mixture and/or with a hydrolysis-stable and alkali-resistant polyelectrolyte complex and coupled to the glass fiber surface via a (polyelectrolyte) complex formation process by means of ionic bonding, with the hydrolysis-stable and alkali-resistant polyelectrolyte complex A thereby being formed, wherein at least one additional (co)polymer at least partially covers the polyelectrolyte complex A and is coupled with the polyelectrolyte A via ionic and/or covalent bonds.

2. The surface-modified glass fibers according to claim 1 in which a hydrolysis-stable and alkali-resistant polyelectrolyte complex A is present which has been created
by a (polyelectrolyte) complex formation of the glass fiber surface with hydrolysis-stable and alkali-resistant cationic polyelectrolytes; and/or
by a (polyelectrolyte) complex formation of the glass fiber surface with hydrolysis-stable and alkali-resistant cationic polyelectrolyte mixtures; and/or
by a (polyelectrolyte) complex formation of the glass fiber surface with hydrolysis-stable and alkali-resistant polyelectrolyte complexes with an excess of cationic charges, which polyelectrolyte complexes have been produced before being applied to the glass fiber surface.

3. The surface-modified glass fibers according to claim 1 in which the hydrolysis-stable and alkali-resistant polyelectrolyte complex A was formed on the glass fiber surface and covers the glass fiber surface completely or essentially completely, and/or the additional (co)polymer covers the polyelectrolyte complex A completely or essentially completely.

4. The surface-modified glass fibers according to claim 1 in which the following are present as hydrolysis-stable and alkali-resistant cationic polyelectrolyte or hydrolysis-stable and alkali-resistant cationic polyelectrolyte mixture:
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

5. The surface-modified glass fibers according to claim 1 in which the following are present as functionalities on the hydrolysis-stable and alkali-resistant cationic polyelectrolyte or hydrolysis-stable and alkali-resistant cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have substituents on the nitrogen atom with an additional reactive and/or activatable functional group and/or olefinically unsaturated double bond, and/or
have amino groups and/or quaternary ammonium groups which are at least partially chemically modified on the nitrogen atom via alkylation reactions, with at least one additional reactive and/or activatable functional group and/or at least one olefinically unsaturated double bond,
and/or
have amino groups and/or quaternary ammonium groups and amide groups which are chemically modified via acylation reactions of amino groups to amide, with at least one additional reactive and/or activatable functional group and/or at least one olefinically unsaturated double bond.

6. The surface-modified glass fibers according to claim 1 in which at least one anionic polyelectrolyte or one anionic polyelectrolyte mixture without and/or with at least one additional reactive and/or activatable functional group different from the anionic group and/or with at least one olefinically unsaturated double bond are present as functionalities on the hydrolysis-stable and alkali-resistant cationic polyelectrolyte or hydrolysis-stable and alkali-resistant cationic polyelectrolyte mixture attached to the glass fiber surface.

7. The surface-modified glass fibers according to claim 6 in which the following are present as anionic polyelectrolyte or anionic polyelectrolyte mixture:
(a) (meth)acrylic acid copolymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylic acid group, and which are preferably water-soluble, and/or
(b) modified maleic acid (anhydride) copolymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of maleic acid (anhydride) groups, and which are preferably water-soluble, and/or
(c) modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of itaconic acid (anhydride) groups, and which are preferably water-soluble, and/or
(d) modified fumaric acid copolymers which are preferably present in the acid and/or monoester and/or monoamide form, and/or which are present without and/or with at least one additional reactive and/or activatable functional group that was introduced via the copolymerization, and or which are present with at least one additional reactive and/or activatable functional group and/or at least one olefinically unsaturated double bond that are coupled via a polymer-analogous reaction/modification of fumaric acid groups, and which are preferably water-soluble, and/or
(e) anionically modified (meth)acrylamide (co)polymers which are present without and/or with at least one additional reactive and/or functional group that was introduced via the copolymerization, and/or which are present with at least one additional reactive and/or functional group and/or with at least one olefinically unsaturated double bond that are coupled via a polymer-analogous reaction/modification of the preferably (meth)acrylamide group, and which are preferably water-soluble, and/or
(f) sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or
(g) (co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous (co)polymer reaction/modification, and which are preferably water-soluble.

8. The surface-modified glass fibers according to claim 1 in which the hydrolysis-stable and alkali-resistant cationic polyelectrolytes or the hydrolysis-stable and alkali-resistant cationic polyelectrolyte mixture has a molecular weight under 50,000 dalton, preferably in the range between 400 Da and 10,000 dalton.

9. The surface-modified glass fibers according to claim 1 in which at least one at least difunctional and/or difunctionalized oligomeric and/or macromolecular (co)polymer with functional groups and/or olefinically unsaturated double bonds are present as additional (co)polymer.

10. The surface-modified glass fibers according to claim 9 in which thermoplastics and/or thermosets and/or elastomers are present as additional (co)polymer.

11. The surface-modified glass fibers according to claim 9 in which polyester resins (UP resins), vinyl ester resins and epoxy resins are present as thermosetting (co)polymers, and polyurethane, polyamide and polyolefins, such as polyethylene or polypropylene, and PVC are present as thermoplastic co(polymers), wherein the polyolefins are present such that they are grafted with (meth)acrylic acid derivatives and/or maleic anhydride.

12. Reinforcing materials for textile concrete with surface-modified glass fibers in which a hydrolysis-stable and alkali-resistant polyelectrolyte complex A is present in an at least partially covering manner on glass fiber surfaces without sizing material and silane, which polyelectrolyte complex comprises functional groups and/or olefinically unsaturated double bonds, and which are present such that they are coupled via chemically covalent bonds with additional (co)polymers after a reaction with functional groups and/or olefinically unsaturated double bonds.

13. The reinforcing materials for textile concrete with surface-modified glass fibers according to claim 12 in which at least one at least difunctional and/or difunctionalized oligomeric and/or macromolecular (co)polymer with functional groups and/or olefinically unsaturated double bonds are present as additional (co)polymers.

14. The reinforcing materials for textile concrete with surface-modified glass fibers according to claim 12 in which thermoplastics and/or thermosets and/or elastomers are present as additional (co)polymer.

15. The reinforcing materials for textile concrete with surface-modified glass fibers according to claim 12 in which amino groups, preferably primary and/or secondary amino groups, and/or quaternary ammonium groups are present as functionalities of the adsorbed hydrolysis-stable cationic polyelectrolyte(s) coupled via ionic bonds.

16. A method for producing surface-modified glass fibers, in which method a hydrolysis-stable and alkali-resistant cationic polyelectrolyte and/or a hydrolysis-stable alkali-resistant cationic polyelectrolyte mixture and/or a hydrolysis-stable and alkali-resistant polyelectrolyte complex with an excess of cationic charges is applied from an aqueous solution at a concentration of maximally 5 wt % to the glass fiber surfaces in an at least partially covering manner during or after the production of glass fibers, wherein hydrolysis-stable and alkali-resistant cationic polyelectrolytes and/or hydrolysis-stable and alkali-resistant cationic polyelectrolyte mixtures with a molecular weight under 50,000 dalton and/or a hydrolysis-stable and alkali-resistant polyelectrolyte complex with an excess of cationic charges are used, and at least one additional (co)polymer is subsequently applied in an at least partially covering manner to the hydrolysis-stable and alkali-resistant polyelectrolyte complex A created on the glass surface.

17. The method according to claim 16 in which polyelectrolytes which are not subsequently alkylated and/or acylated and/or sulfamidated after production are used as hydrolysis-stable and alkali-resistant cationic polyelectrolytes, or polyelectrolyte mixtures that are not subsequently alkylated and/or acylated and/or sulfamidated after production are used as hydrolysis-stable and alkali-resistant cationic polyelectrolyte mixtures.

18. The method according to claim 16 in which the following are used as hydrolysis-stable and alkali-resistant unmodified cationic polyelectrolyte, as a pure substance or substances or in a mixture, preferably dissolved in water:
polyethyleneimine (linear and/or branched) and/or copolymers; and/or
polyallylamine and/or copolymers; and/or
poly(diallyldimethylammonium chloride) (polyDADMAC) and/or copolymers; and/or
polyvinylamine and/or copolymers; and/or
polyvinylpyridine and/or copolymers; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s).

19. The method according to claim 16 in which hydrolysis-stable and alkali-resistant cationic polyelectrolytes and/or hydrolysis-stable and alkali-resistant cationic polyelectrolyte mixtures and/or hydrolysis-stable and alkali-resistant polyelectrolyte complexes with an excess of cationic charges are used at a concentration of maximally 5 wt % in water or in water with the addition of acid, such as carboxylic acid, for example formic acid and/or acetic acid, and/or mineral acid, without additional sizing material or sizing material components and/or silanes.

20. The method according to claim 16 in which hydrolysis-stable and alkali-resistant cationic polyelectrolytes which are not subsequently alkylated and/or acylated and/or sulfamidated after production and/or hydrolysis-stable and alkali-resistant cationic polyelectrolyte mixtures that are not subsequently alkylated and/or acylated and/or sulfamidated after production are used at a concentration of <2 wt %, and particularly preferably at ≤0.8 wt %.

21. The method according to claim 16 in which hydrolysis-stable and alkali-resistant cationic polyelectrolytes and/or hydrolysis-stable and alkali-resistant cationic polyelectrolyte mixtures with a molecular weight under 50,000 dalton, preferably in the range between 400 dalton and 10,000 dalton, are used.

22. The method according to claim 16 in which a modified hydrolysis-stable and alkali-resistant cationic polyelectrolyte and/or a hydrolysis-stable and alkali-resistant cationic polyelectrolyte mixture that is/are partially alkylated and/or acylated and/or reacted with carboxylic acid derivatives and/or sulfamidated in a subsequent reaction following production, and is/are thus equipped with a substituent having reactive and/or activatable groups for a coupling reaction, is/are then, having the reactive and/or activatable groups of the covalently coupled substituent, reacted with additional materials to form a composite material via at least one functional group and/or via at least one olefinically unsaturated double bond without crosslinking of the hydrolysis-stable and alkali-resistant cationic polyelectrolyte or of the hydrolysis-stable and alkali-resistant cationic polyelectrolyte mixture.

23. The method according to claim 16 in which the partial alkylation of the hydrolysis-stable and alkali-resistant cationic polyelectrolyte or of the hydrolysis-stable and alkali-resistant cationic polyelectrolyte mixture is achieved, with substituents having reactive groups thereby being introduced, through haloalkyl derivatives and/or (epi)halohydrin compounds and/or epoxy compounds and/or compounds which enter into a Michael-analogous addition, advantageously such as acrylates and/or acrylonitrile with amines.

24. The method according to claim 16 in which the partial acylation of the hydrolysis-stable and alkali-resistant cationic polyelectrolyte or of the hydrolysis-stable and alkali-resistant cationic polyelectrolyte mixture is achieved, with substituents having reactive groups thereby being introduced, through carboxylic acids and/or carboxylic acid halides and/or carboxylic acid anhydrides and/or carboxylic acid esters and/or diketenes, or if a quasi-acylation is achieved through isocyanates and/or urethanes and/or carbodiimides and/or uretdiones and/or allophanates and/or biurets and/or carbonates.

25. The method according to claim 16 in which the hydrolysis-stable and alkali-resistant cationic polyelectrolytes and/or the hydrolysis-stable and alkali-resistant cationic polyelectrolyte mixture and/or the hydrolysis-stable and alkali-resistant polyelectrolyte complexes with an excess of cationic charges are used such that they are dissolved in water, preferably as an ammonium compound, wherein in the case of primary and/or secondary and/or tertiary amino groups carboxylic acid(s) and/or mineral acid(s) are added to the aqueous solution to convert the amino groups into the ammonium form.

26. The method according to claim 16 in which modified glass fiber surfaces that are at least partially, and preferably completely, covered at least with a hydrolysis-stable and alkali-resistant cationic polyelectrolyte or a hydrolysis-stable and alkali-resistant cationic polyelectrolyte mixture and/or a hydrolysis-stable and alkali-resistant polyelectrolyte complex with an excess of cationic or anionic charges are, directly following the production and coating/surface modification thereof and/or at a later point, reacted with additional materials, with chemically covalent bonds thereby being formed.

27. The method according to claim 26 in which the modified glass fiber surfaces are wound and/or intermediately stored as roving and are subsequently reacted with additional materials, with chemically covalent bonds thereby being formed.

28. The method according to claim 26 in which the hydrolysis-stable and alkali-resistant cationic polyelectrolyte or the hydrolysis-stable and alkali-resistant cationic polyelectrolyte mixture and/or the hydrolysis-stable and alkali-resistant polyelectrolyte complex with an excess of cationic or anionic charges comprises reactive groups in the form of functional groups and/or olefinically unsaturated double bonds, which groups are reacted with functionalities of the additional materials, with chemically covalent bonds thereby being formed.

29. The method according to claim 16 in which an aqueous solution with a concentration of maximally 5 wt % of a hydrolysis-stable and alkali-resistant cationic polyelectrolyte and/or of a hydrolysis-stable and alkali-resistant cationic polyelectrolyte mixture and/or of a hydrolysis-stable and alkali-resistant polyelectrolyte complex with an excess of cationic charges is applied in an at least partially covering manner to commercially produced and sized glass fiber surfaces, or to glass fiber surfaces without sizing material and silane, wherein cationic polyelectrolytes or cationic polyelectrolyte mixtures with a molecular weight under 50,000 dalton are used.
